(19) United States
(12) Patent Application Publication
(10) Pub. No.: US 2015/0010056 A1
(43) Pub. Date: Jan. 8, 2015

(54) METHOD AND APPARATUS FOR VIDEO ENCODING CAPABLE OF PARALLEL ENTROPY ENCODING OF SUBREGIONS, METHOD AND APPARATUS FOR VIDEO DECODING CAPABLE OF PARALLEL ENTROPY DECODING OF SUBREGIONS

(71) Applicant: SAMSUNG ELECTRONICS CO., LTD., Suwon-si (KR)

(72) Inventors: Byeong-doo Choi, Siheung-si (KR); Chan-yul Kim, Seongnamm-si (KR); Tammy Lee, Seoul (KR); Jeong-hoon Park, Seoul (KR)

(73) Assignee: SAMSUNG ELECTRONICS CO., LTD., Suwon-si (KR)

(21) Appl. No.: 14/373,414

(22) PCT Filed: Jan. 21, 2013
(86) PCT No.: PCT/KR2013/000471

§ 371 Date: Jul. 21, 2014

Related U.S. Application Data
(60) Provisional application No. 61/588,645, filed on Jan. 19, 2012.

(51) Int. Cl. H04N 19/13; H04N 19/136; H04N 19/91; H04N 19/176; H04N 19/436

(52) U.S. Cl. CPC H04N 19/00121; H04N 19/00278; H04N 19/00521; H04N 19/00951; H04N 19/00139
USPC 375/240.02

(57) ABSTRACT

A video encoding method includes: generating encoding symbols by performing source coding on subregions formed by splitting a picture in a vertical direction, based on blocks having a predetermined size; determining a reference block to be referred to for determining code probability information of a start block in a current subregion, the reference block being determined from among boundary blocks of a neighboring subregion which are encoded before the start block and adjacent to a boundary between the current subregion and the neighboring subregion; performing entropy encoding on blocks of the current subregion, starting from the start block, by using the encoding symbols of the blocks of the current subregion based on the code probability information of the start block determined by using code probability information of the determined reference block; and performing entropy encoding on another subregion in parallel with performing entropy encoding on the current subregion.

### CROSS-REFERENCE TO RELATED APPLICATIONS

This application is a National Stage Entry of PCT/KR2013/000471, filed on Jan. 21, 2013, which claims the benefit of U.S. provisional patent application No. 61/588,645, filed on Jan. 19, 2012 in the U.S. Patent and Trademark Office, the entire disclosures of which are incorporated herein by reference in their entirety.

### TECHNICAL FIELD

The exemplary embodiments relate to a video encoding method including entropy encoding and a video decoding method including entropy decoding.

### BACKGROUND OF THE RELATED ART

As hardware for reproducing and storing high resolution or high quality video content is being developed and supplied, a need for a video codec for effectively encoding or decoding the high resolution or high quality video content is increasing. According to a related art video codec, a video is encoded according to a limited encoding method based on a macroblock having a predetermined size.

Image data of a spatial region is transformed into coefficients of a frequency region via frequency transformation. According to a video codec, an image is split into blocks having a predetermined size, a discrete cosine transformation (DCT) is performed for each respective block, and frequency coefficients are encoded in block units, for rapid calculation of frequency transformation. Compared with image data of a spatial region, coefficients of a frequency region are easily compressed. In particular, since an image pixel value of a spatial region is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

Entropy encoding is performed to compress a bit string of a symbol generated by video encoding. Recently, arithmetic coding-based entropy encoding has been widely used. For arithmetic coding-based entropy encoding, a symbol is binarized to a bit string, and then context-based arithmetic coding is performed on the bit string.

### SUMMARY

Apparatuses and methods consistent with exemplary embodiments relate to arithmetic coding-based entropy encoding and decoding for video encoding and decoding by parallel processing, by using multiple processors.

According to an aspect of an exemplary embodiment, there is provided a video encoding method in which entropy encoding is performed, the method including: generating encoding symbols by performing source coding on subregions which are formed by splitting a picture in a vertical direction, wherein the performing of the source coding includes performing the source coding based on blocks having a predetermined size; determining a reference block to be referred to for determining code probability information of a start block in a current subregion, the reference block being determined from among boundary blocks of a neighboring subregion which neighbors the current subregion, the boundary blocks being encoded before the start block and adjacent to a boundary between the current subregion and the neighboring subregion; performing entropy encoding on blocks of the current subregion, starting from the start block, by using the encoding symbols of the blocks of the current subregion based on the code probability information of the start block determined by using code probability information of the determined reference block; and performing entropy encoding on a predetermined subregion from among the subregions in parallel with performing entropy encoding on the current subregion.

The determining of the reference block to be referred to may include determining the reference block to be referred to from among at least one block located at a position designated based on a location of the start block.

The video encoding method may further include outputting information indicating a location of the determined reference block.

The generating of the encoding symbols may include performing prediction encoding on the current subregion by referring to a subregion that is encoded before the current subregion and is among the subregions.

According to an aspect of another exemplary embodiment, there is provided a video encoding method in which entropy encoding is performed, the video encoding method including: generating encoding symbols by performing source coding on subregions which are formed by splitting a picture in a vertical direction, wherein the source coding is performed based on blocks having a predetermined size; performing entropy encoding by using entropy symbols of the current subregion; outputting reference possibility information indicating whether it is possible to perform entropy encoding on the current subregion by referring to a neighboring subregion; and performing entropy encoding on a predetermined subregion from among the subregions, in parallel with the performing of the entropy encoding on the current subregion, based on the output reference possibility information.

The performing of the entropy encoding on the predetermined subregion may include determining a block to be referred to for determining code probability information of a start block in a current subregion from among boundary blocks of a neighboring subregion which neighbors the current subregion, the boundary blocks being encoded before the start block and adjacent to a boundary between the current subregion and the neighboring subregion; and sequentially performing entropy encoding on blocks of the current subregion, starting from the start block, based on the code probability information of the start block determined by using code probability information of the determined block.

According to an aspect of another exemplary embodiment, there is provided a video decoding method in which entropy decoding is performed, the video decoding method including: extracting from a received bitstream an encoded bit string of encoding symbols of a current subregion generated based on blocks having a predetermined size, for subregions that are formed by splitting a picture in a vertical direction; determining a block that is to be referred to for determining code probability information of a start block in a current subregion from among boundary blocks of a neighboring subregion which neighbors the current subregion, the boundary blocks being encoded before the start block and adjacent to a boundary between the current subregion and the neighboring subregion; restoring the encoding symbols of the current subregion by performing entropy decoding on the encoded bit string of the encoding symbols of the current subregion based on the code probability information of the start block determined by using code probability information of the determined block; performing entropy decoding on a predetermined subregion from among the subregions in parallel with performing entropy decoding on the current subregion; and restoring the picture by performing source decoding on the restored encoding symbols, for each of the subregions.

The determining of the block that is to be referred to may include determining a block to be referred to from among at least one block located at a position designated based on a location of the start block.

The extracting may include extracting from the received bitstream information indicating a location of the block that is to be referred to for determining the code probability information of the start block of the current subregion, and the determining of the block that is to be referred to comprises determining the block that is to be referred to according to a location of a block read from the extracted information.

The restoring of the picture may include restoring the picture by estimating the current subregion by referring to a subregion from among subregions that are restored before the current subregion.

According to an aspect of another exemplary embodiment, there is provided a video decoding method in which entropy decoding is performed, the video decoding method including: extracting from a received bitstream an encoded bit string of encoding symbols of a current subregion generated based on blocks having a predetermined size, for subregions that are formed by splitting a picture in a vertical direction; extracting from the received bitstream entropy reference possibility information indicating whether it is possible to perform entropy decoding on a current subregion by referring to a parsing result of a neighboring subregion which neighbors the current subregion; restoring the encoding symbols of the current subregion by performing entropy decoding on the encoded bit string of the encoding symbols of the current subregion based on the extracted entropy reference probability information; performing entropy decoding on a predetermined subregion from among the subregions in parallel with performing entropy decoding on the current subregion; and restoring the picture by performing source decoding on the restored encoding symbols, for each of the subregions.

The restoring of the encoding symbols of the current subregion may include: determining a block that is to be referred to for determining code probability information of a start block in the current subregion from among boundary blocks of the neighboring subregion, the boundary blocks being encoded before the start block and adjacent to a boundary between the current subregion and the neighboring subregion; and restoring the encoding symbols of the current subregion by performing entropy encoding on the encoded bit string of the encoding symbols of the current subregion based on the code probability information of the start block determined by using code probability information of the determined block.

According to an aspect of another exemplary embodiment, there is provided a video encoding apparatus configured to perform entropy encoding, the apparatus including: a subregion encoder configured to generate encoding symbols by performing source coding on subregions formed by splitting a picture, in a vertical direction, into blocks having a predetermined size; a subregion entropy encoder configured to determine a reference block to be referred to for determining code probability information of a start block in a current subregion from among boundary blocks of a neighboring subregion which neighbors the current subregion, the boundary blocks being encoded before the start block and adjacent to a boundary between the current subregion and the neighboring subregion, and to perform entropy encoding on blocks of the current subregion, starting from the start block, by using the encoding symbols of the blocks of the current subregion based on the code probability information of the start block determined by using code probability information of the determined reference block, wherein the subregion entropy encoder is configured to perform entropy encoding on a predetermined subregion from among the subregions in parallel with performing entropy encoding on the current subregion.

According to an aspect of another exemplary embodiment, there is provided a video decoding apparatus configured to perform entropy decoding, the video decoding apparatus including: a subregion receiver configured to extract from a received bitstream an encoded bit string of encoding symbols of a current subregion generated based on blocks having a predetermined size, for subregions that are formed by splitting a picture in a vertical direction; a subregion entropy decoder configured to determine a block that is to be referred to for determining code probability information of a start block in the current subregion from among boundary blocks of a neighboring subregion which neighbors the current subregion, the boundary blocks being encoded before the start block and adjacent to a boundary between the current subregion and the neighboring subregion, and to restore the encoding symbols of the current subregion by performing entropy decoding on the encoded bit string of the encoding symbols of the current subregion based on the code probability information of the start block determined by using code probability information of the determined block; and a restoring unit configured to restore the picture by performing source decoding on the restored encoding symbols of the subregions, wherein the subregion entropy decoder is configured to perform entropy decoding on a predetermined subregion from among the subregions in parallel with performing entropy decoding on the current subregion.

According to an aspect of another exemplary embodiment, there is provided a non-transitory computer readable recording medium having embodied thereon a program, which when executed by a computer, performs a method according to the exemplary embodiments.

According to the video encoding apparatus and the video decoding apparatus according to exemplary embodiments, regardless of whether a neighboring subregion is referred to or not during source coding of a subregion, whether entropy related information of a neighboring subregion is referred to only during entropy encoding of a subregion may be adjusted by neighboring subregion. Also, as initial code probability information for entropy encoding or decoding is pre-stored in each subregion and is initialized as an obtainable value, a delay time of a standby state when obtaining the initial code probability information may be minimized, and entropy related information of another block to be stored in advance may also be minimized. Accordingly, entropy decoding on a plurality of subregions may be performed in parallel, and source decoding on each subregion may also be easily performed subsequently.

### BRIEF DESCRIPTION OF THE DRAWINGS

FIG. 1A is a block diagram illustrating a video encoding apparatus performing entropy encoding according to an exemplary embodiment;

FIG. 1B is a flowchart of a video encoding method according to an exemplary embodiment, performed by using the video encoding apparatus of FIG. 1A;

FIG. 1C is a flowchart of a video encoding method according to another exemplary embodiment, performed by using the video encoding apparatus of FIG. 1A;

FIG. 2A is a block diagram illustrating a video decoding apparatus performing entropy decoding according to an exemplary embodiment n;

FIG. 2B is a flowchart of a video decoding method according to an exemplary embodiment, performed by using the video decoding apparatus of FIG. 2A;

FIG. 2C is a flowchart of a video decoding method according to another exemplary embodiment, performed by using the video decoding apparatus of FIG. 2A;

FIG. 3 illustrates tiles;

FIG. 4 illustrates a difference between tiles and slice segments;

FIG. 5 illustrates reference objects for determining initial code probability information in a subregion according to an exemplary embodiment;

FIG. 6 illustrates parsing a reference possibility between sub-regions according to an exemplary embodiment;

FIG. 7 is a block diagram of a video encoding apparatus based on a coding unit according to a tree structure, according to an exemplary embodiment;

FIG. 8 is a block diagram of a video decoding apparatus based on a coding unit according to a tree structure, according to an exemplary embodiment;

FIG. 9 is a diagram for describing a concept of coding units according to an exemplary embodiment;

FIG. 10 is a block diagram of an image encoder based on coding units according to an exemplary embodiment;

FIG. 11 is a block diagram of an image decoder based on coding units according to an exemplary embodiment;

FIG. 12 is a diagram illustrating deeper coding units according to depths, and partitions according to an exemplary embodiment;

FIG. 13 is a diagram for describing a relationship between a coding unit and transformation units, according to an exemplary embodiment;

FIG. 14 is a diagram for describing encoding information of coding units corresponding to a coded depth, according to an exemplary embodiment;

FIG. 15 is a diagram of deeper coding units according to depths, according to an exemplary embodiment;

FIGS. 16 through 18 are diagrams for describing a relationship between coding units, prediction units, and transformation units, according to an exemplary embodiment; and

FIG. 19 is a diagram for describing a relationship between a coding unit, a prediction unit, and a transformation unit, according to encoding mode information of Table 1;

FIG. 20 illustrates a physical structure of a disk in which a program according to an exemplary embodiment is stored;

FIG. 21 illustrates a disk drive for writing and reading a program by using a disk;

FIG. 22 illustrates an overall structure of a content supply system for providing a content distribution service;

FIGS. 23 and 24 respectively illustrate an external structure and an internal structure of a mobile phone to which a video encoding method and a video decoding method according to an exemplary embodiment are applied;

FIG. 25 illustrates a digital broadcasting system to which a communication system according to an exemplary embodiment is applied; and

FIG. 26 illustrates a network structure of a cloud computing system that uses a video encoding apparatus and a video decoding apparatus according to an exemplary embodiment.

### DETAILED DESCRIPTION OF EXEMPLARY EMBODIMENTS

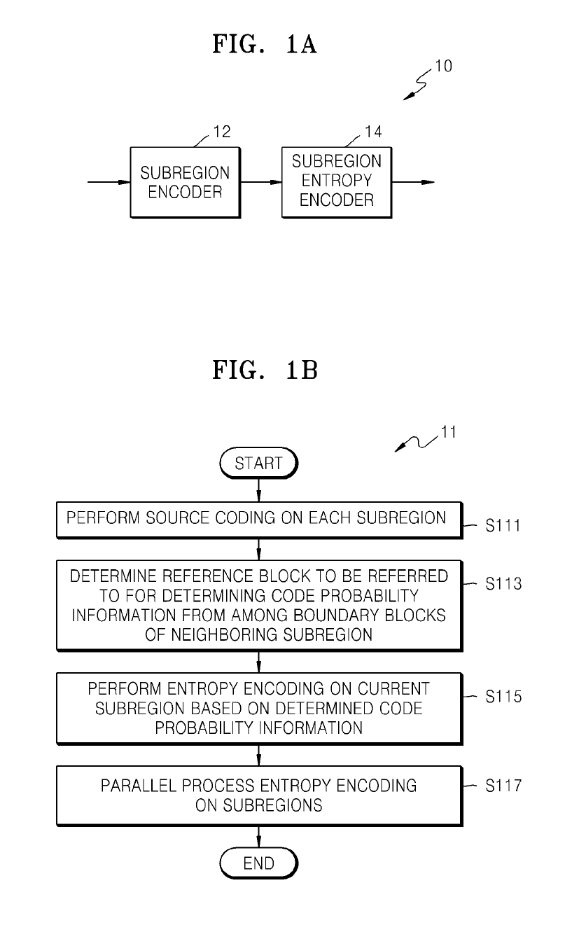

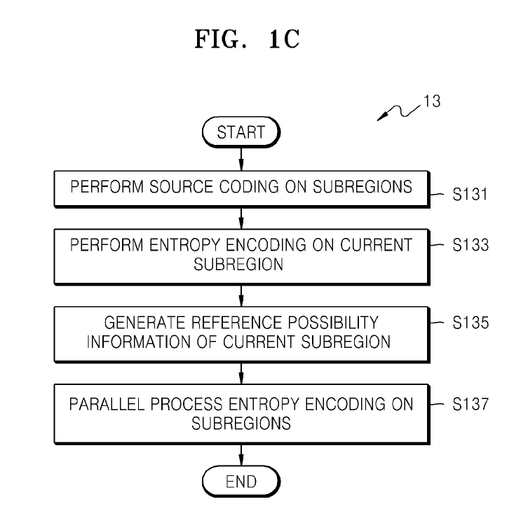

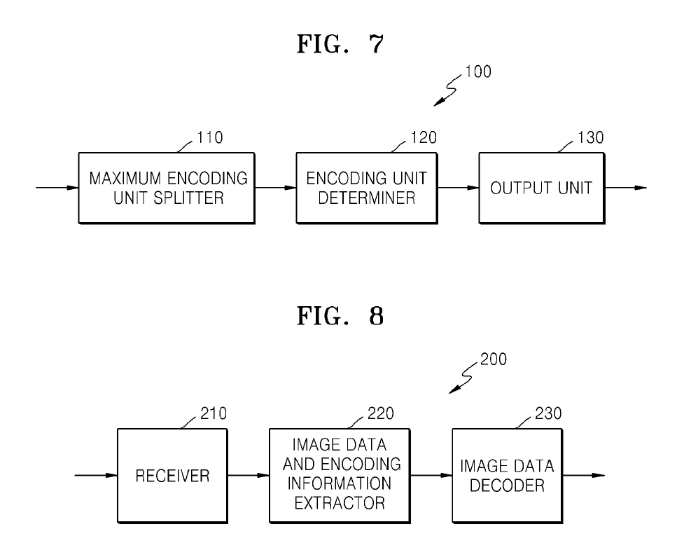

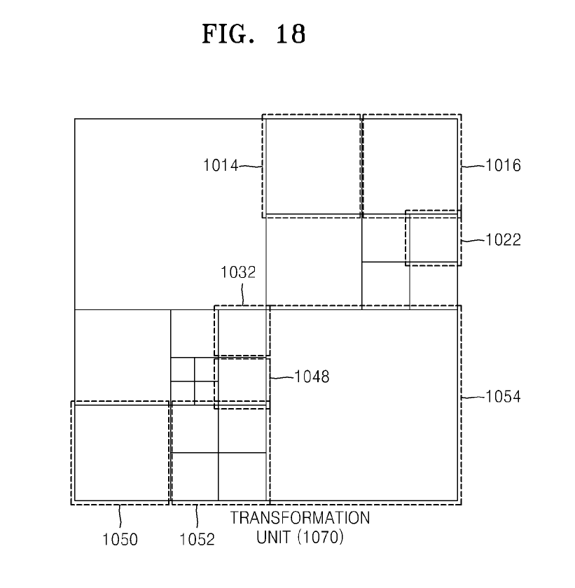

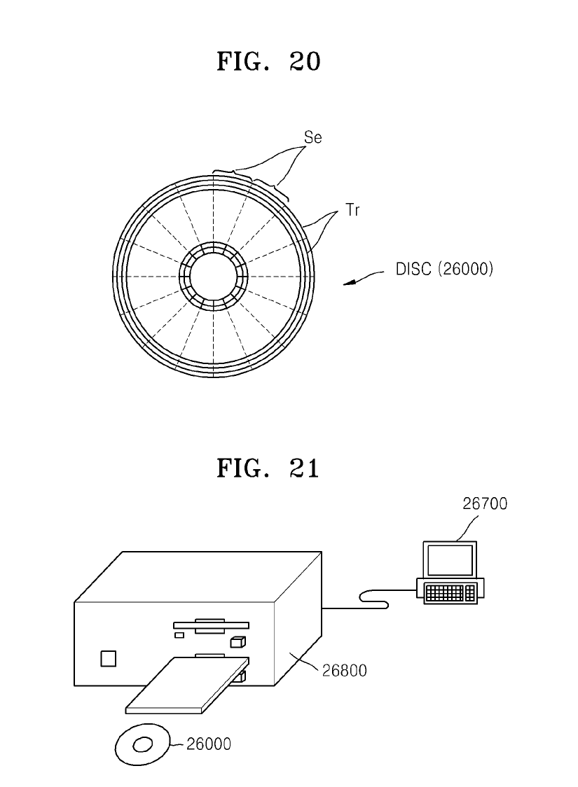

Hereinafter, a video encoding method in which entropy encoding is performed and a video decoding method in which entropy decoding is performed, according to exemplary embodiments, will be described with reference to FIGS. 1A through 6. In addition, a video encoding method and a video decoding method based on coding units according to a tree structure will be described with reference to FIGS. 7 through 19. Also, various exemplary embodiments to which the video encoding method and the video decoding method according to exemplary embodiments are applicable will be described with reference to FIGS. 20 through 26. Hereinafter, the term ‘image’ may refer to a still image or a moving picture, that is, a video itself.

First, with reference to FIGS. 1A through 6, a video encoding method in which entropy encoding is performed and a video decoding method in which entropy decoding is performed according to an exemplary embodiment will be described.

FIG. 1A is a block diagram illustrating a video encoding apparatus 10 configured to perform entropy encoding according to an exemplary embodiment.

The video encoding apparatus 10 according to an exemplary embodiment includes a subregion encoder 12 and a subregion entropy encoder 14.

A video encoding operation according to an exemplary embodiment may be divided into a source coding operation in which repeated data due to temporal and spatial similarity of image data is minimized and an entropy encoding operation in which repetitiveness is minimized again in a bit string of data generated by source coding. The subregion encoder 12 is in charge of source coding, and the subregion entropy encoder 14 is in charge of entropy encoding.

The subregion encoder 12 generates encoding symbols by source coding block units of respective pictures that constitute a video. Source coding includes intra prediction or inter prediction, transformation, and quantization, which are performed in block units of video data in a spatial domain. As a result of source coding, an encoding symbol may be generated for each block. For example, a quantized transformation coefficient of a residual component, a motion vector, an intra mode type information, an inter mode type information, or a quantization parameter may be an encoding symbol.

The video encoding method according to various exemplary embodiments should not be construed as being limited only to a video encoding method with respect to a ‘block’ which is a data unit, but may also apply to various data units.

For efficiency of image encoding, an image is encoded by being split into blocks having a predetermined size. A block may have a square shape, a rectangular shape, or any geometric shape and is not limited to a data unit having a predetermined size. According to an exemplary embodiment, a block may be a maximum coding unit, a coding unit, a prediction unit, a transformation unit, or the like from among coding units according to a tree structure. Video encoding and decoding methods based on coding units according to a tree structure will be described below with reference to FIGS. 7 through 19.

The subregion encoder 12 according to an exemplary embodiment may perform encoding on each of subregions that are formed by splitting a picture in a vertical direction. A subregion according to an exemplary embodiment may also be generated by splitting a picture in vertical and horizontal directions.

Each subregion includes blocks. The subregion encoder 12 according to an exemplary embodiment may generate encoding symbols for each block by sequentially performing encoding on the blocks included in each subregion.

Also, the subregion encoder 12 according to an exemplary embodiment may sequentially perform encoding on the subregions. The subregion encoder 12 may encode a current subregion by referring to a previously encoded neighboring subregion from among the subregions. That is, for source coding of the subregion encoder 12, dependency between subregions may exist. Alternatively, subregions may not be referred to one another for source coding of subregions and the subregions may each be independently source coded.

Accordingly, the subregion encoder 12 according to an exemplary embodiment may sequentially perform encoding on subregions, and may sequentially perform encoding on blocks included in each of the subregions to thereby respectively generate encoding symbols for each of the blocks.

The subregion entropy encoder 14 according to an exemplary embodiment performs entropy encoding by using the encoding symbols generated for each block of each subregion. Entropy encoding may be sequentially performed on the blocks included in the subregions.

Entropy encoding according to an exemplary embodiment may be classified as a binarization process in which a symbol is transformed into a bit string and an arithmetic coding process in which context-based arithmetic coding is performed on the bit string. As an arithmetic coding process in which context-based arithmetic coding is performed, context adaptive binary arithmetic coding (CABAC) or the like is widely used. According to context-based arithmetic coding and decoding, each bit of a symbol bit string is a bin of a context, and each bit position may be mapped to a bin index. A length of a bit string, that is, a length of bins may be varied according to a symbol value. For context-based arithmetic coding and decoding, context modeling whereby a context of a symbol is determined is necessary.

For context modeling, a context at each bit position of a symbol bit string, that is, a context of each bin index is to be renewed. Context modeling is a process of analyzing a probability that 0 or 1 occurs in each bin. A process of renewing a context by reflecting a result of analyzing a probability of each bit of each symbol of a new block, to previous contexts, may be repeated for each block. As information including a result of the context modeling, a probability table may be provided in which a probability of occurrence is matched to each bin. Entropy encoding probability information according to an exemplary embodiment may be information including the result of context modeling.

Accordingly, if context modeling information, that is, entropy encoding probability information, is provided, entropy encoding may be performed by assigning a code to each bit of a binarized bit string of block symbols, based on a context of entropy encoding probability information.

Also, in entropy encoding according to an exemplary embodiment, as context-based arithmetic coding is performed, symbol code probability information may be renewed for each block, and as entropy encoding is performed by using the renewed symbol code probability information, a compression ratio may be improved.

The subregion entropy encoder 14 according to an exemplary embodiment may obtain initial code probability information of each subregion and renew the initial code probability information by using encoding symbols of blocks.

Accordingly, how the subregion entropy encoder 14 obtains initial entropy encoding probability information to perform entropy encoding on each subregion will be described below with reference to FIG. 1B.

Also, the subregion entropy encoder 14 may perform entropy entropy encoding on two or more subregions in parallel. Parallel processing of entropy encoding performed on subregions by using the video encoding apparatus 10 according to an exemplary embodiment will be described with reference to FIGS. 1B and 1C.

FIG. 1B is a flowchart of a video encoding method 11 according to an exemplary embodiment, performed by using the video encoding apparatus 10 of FIG. 1A.

In operation 111, the subregion encoder 12 may generate encoding symbols by performing source coding on each subregion of a picture based on blocks having a predetermined size.

In operation 113, the subregion entropy encoder 14 may determine initial code probability information for a start block of a current subregion, from among blocks of the current subregion, in order to start entropy encoding on the start block. The subregion entropy encoder 14 according to an exemplary embodiment may obtain initial code probability information of the start block, from previously encoded blocks of another subregion.

The subregion entropy encoder 14 according to an exemplary embodiment may determine a block to be referred to when determining code probability information of a start block from among boundary blocks of a neighboring subregion that is encoded before the start block and is adjacent to a boundary between the current subregion and the neighboring subregion, from among blocks of the neighboring subregion.

The subregion entropy encoder 14 according to an exemplary embodiment may determine initial code probability information of a start block of a current subregion by using code probability information of the reference block that is determined from among boundary blocks of the neighboring subregion. The subregion entropy encoder 14 may perform entropy encoding on the start block based on the initial code probability information of the start block.

The subregion entropy encoder 14 according to an exemplary embodiment may sequentially perform entropy encoding on blocks of a current subregion, starting from a start block, based on initial code probability information of the start block. Code probability information may be finally determined by renewing initial code probability information of each block. Accordingly, entropy encoding whereby bit strings are generated from encoding symbols of a block based on code probability information determined for each block may be performed.

The subregion entropy encoder 14 according to an exemplary embodiment may determine one of at least one block located at a position designated based on a position of a start block, as an entropy reference block for determining initial code probability information of a start block of a current subregion.

The video encoding apparatus 10 according to an exemplary embodiment may also output information indicating a position of a block that is determined as an entropy reference block for a start block of the current subregion, from among boundary blocks of a neighboring subregion of the current subregion.

Information indicating a position of an entropy reference block, according to an exemplary embodiment, may be at least one of information indicating an absolute position of an entropy reference block in a picture, information indicating a scan order of an entropy reference block in a picture, information indicating at least one of distances between a start block of a current subregion and entropy reference blocks, and index information of an entropy reference block from among indices each indicating at least one block adjacent to a position designated based on a position of a start block.

However, the subregion entropy encoder 14 according to an exemplary embodiment may also determine a block, from among blocks adjacent to the left or at an upper end of the current start block, as an entropy reference block, without having to additionally transmit information indicating a location of the entropy reference block.

In operation 115, the subregion entropy encoder 14 according to an exemplary embodiment may perform entropy encoding on a predetermined subregion from among subregions, in parallel with performing entropy encoding on a current subregion.

For example, even if a current subregion is after a predetermined subregion in an encoding order, entropy encoding on a start block of a current subregion may be started by obtaining initial code probability information from a block selected from among boundary blocks of a neighbor block adjacent to the current subregion. Thus, entropy encoding on a current subregion and entropy encoding on a predetermined subregion may be performed in parallel.

FIG. 1C is a flowchart of a video encoding method 13 according to another exemplary embodiment, performed by using the video encoding apparatus 10 of FIG. 1A.

In operation 131, the subregion encoder 12 according to another exemplary embodiment generates encoding symbols by performing source coding on each subregion of a picture, based on blocks having a predetermined size.

In operation 133, the subregion entropy encoder 14 according to another exemplary embodiment may perform entropy encoding on encoding symbols of blocks of a current subregion.

First, the subregion entropy encoder 14 according to another exemplary embodiment may determine whether entropy encoding on a current subregion is possible or not, by referring to blocks of a neighboring subregion. If it is determined that blocks of a neighboring subregion are available for entropy encoding on a current subregion, entropy encoding on a current subregion may be performed by referring to the neighboring subregion. For example, entropy related information of a current subregion may be determined by referring to entropy related information of a neighboring subregion that is determined during entropy encoding on the neighboring subregion.

Thus, in operation 135, the subregion entropy encoder 14 according to another exemplary embodiment may generate entropy reference possibility information indicating whether entropy encoding may be performed on a current subregion by referring to a neighboring subregion.

In operation 137, the subregion entropy encoder 14 according to another exemplary embodiment may perform entropy encoding on a predetermined subregion from among subregions, in parallel with performing entropy encoding on a current subregion.

As described above with reference to FIG. 1B, the subregion entropy encoder 14 according to another exemplary embodiment may determine an entropy reference block from among boundary blocks of a neighboring subregion that is previously encoded before a start block of a current subregion. The subregion entropy encoder 14 according to another exemplary embodiment may sequentially perform entropy encoding on each of blocks of a current subregion, starting from a start block, based on code probability information of the start block that is determined by using code probability information of the entropy reference block.

Accordingly, even if a current subregion is after a predetermined subregion in an encoding order, the subregion entropy encoder 14 according to another exemplary embodiment may start entropy encoding on the current subregion by using code probability information of the entropy reference block, and thus, entropy encoding on the current subregion and entropy encoding on the predetermined subregion may be performed in parallel.

Also, regardless of whether information of a neighboring subregion is referred to or not when source coding is performed, whether a neighboring subregion refers to another neighboring subregion for entropy related information may be adjusted when performing entropy encoding on subregions.

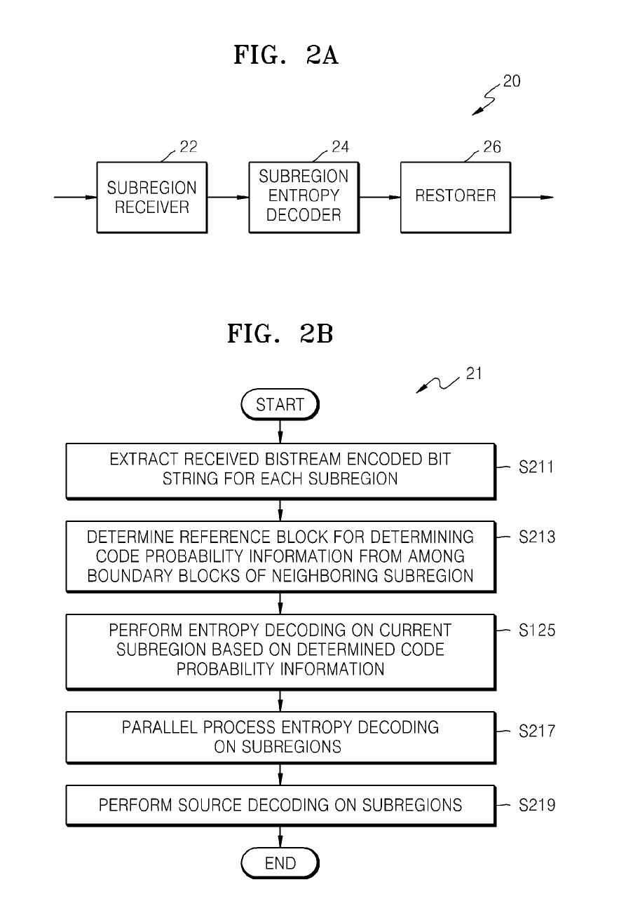

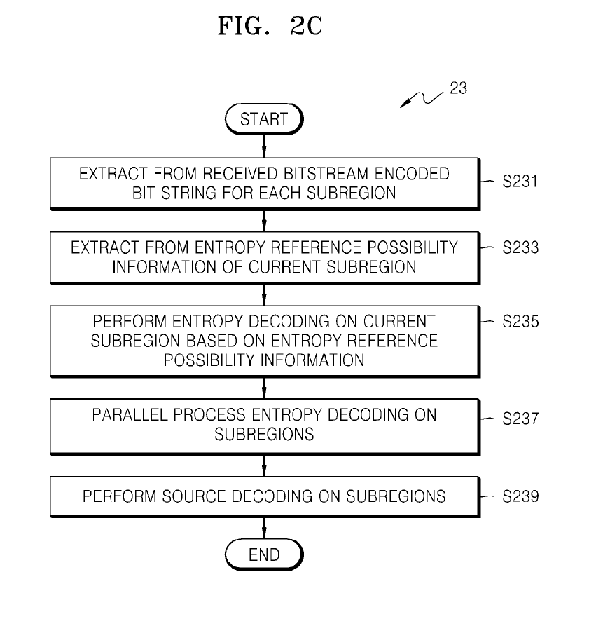

A method of restoring block symbols from a bit string that is entropy encoded by parallel processing of each subregion, described above with reference to FIGS. 1A, 1B, and 1C, will be described below with reference to FIGS. 2A, 2B, and 2C.

FIG. 2A is a block diagram illustrating a video decoding apparatus 20 performing entropy decoding according to an exemplary embodiment.

The video decoding apparatus 20 according to an exemplary embodiment includes a subregion receiver 22, a subregion entropy decoder 24, and a restorer 26.

The subregion receiver 22 according to an exemplary embodiment receives a bitstream including video encoding data. A bitstream may include bit strings, which include encoding symbols of blocks of each subregion of each image. The encoding symbols are generated by entropy encoding.

Hereinafter, a video decoding method or an entropy decoding method with respect to a ‘block’, which is a type of data unit, will be described. As described above with reference to FIG. 1A, a ‘block’ according to the exemplary embodiment may apply to various data units based on coding units having a tree structure. Also, a subregion according to an exemplary embodiment may be a region that is generated by splitting a picture at least in a vertical direction, or a region formed by splitting a picture in a vertical direction and a horizontal direction. Each subregion includes blocks as described above with reference to FIG. 1A.

The subregion receiver 22 according to an exemplary embodiment extracts from the received bitstream a bit string including encoded encoding symbols of blocks of each subregion. A bit string extracted for each subregion is transmitted to the subregion entropy decoder 24.

A video decoding process according to an exemplary embodiment may be classified into a parsing process in which encoding symbols are extracted from a bit string to be restored, and a source decoding process in which repeated data is restored by using temporal and spatial similarity between image data. In the parsing process, entropy decoding for restoring symbols from a bit string is performed. In the video decoding apparatus 20 according to an exemplary embodiment, the subregion entropy decoder 24 controls the parsing process, and the restorer 26 performs the source decoding process.

The subregion entropy decoder 24 according to an exemplary embodiment performs entropy decoding on each subregion by using a bit string extracted for each subregion. As a result of performing entropy decoding on an encoded bit string of encoding symbols of subregions, encoded symbols of blocks constituting the subregions may be sequentially restored.

The restorer 26 according to an exemplary embodiment may restore a picture by performing source decoding on the encoding symbols of each subregion that are restored. By performing source decoding on the encoding symbols that are sequentially restored, for each block of each subregion, the blocks are restored, and as the blocks are sequentially restored for each subregion, and the entire picture formed of the subregions may thereby be restored.

Also, while sequentially performing source decoding on the subregions, the restorer 26 according to an exemplary embodiment may encode a current subregion by referring to a neighboring subregion that is first encoded from among the subregions. That is, for source decoding of the restorer 26, dependency between the subregions may exist. Alternatively, for source decoding of the subregions, the subregions may not refer to one another, but each subregion may be independently source decoded.

Entropy decoding according to an exemplary embodiment is arithmetic coding by context modeling, as described above. Thus, the subregion entropy decoder 24 according to an exemplary embodiment may obtain initial code probability information of each subregion, and may renew initial code probability information by using encoding symbols of each block that are restored. How the subregion entropy decoder 24 according to an exemplary embodiment obtains initial coding probability information in order to perform entropy encoding on each subregion will be described below with reference to FIG. 2B.

Also, the subregion entropy decoder 24 according to an exemplary embodiment may perform entropy decoding on two or more subregions in parallel. A method of parallel processing of entropy decoding of subregions by using the video decoding apparatus 20 according to an exemplary embodiment will be described in detail with reference to FIGS. 1B and 1C.

FIG. 2B is a flowchart of a video decoding method according to an exemplary embodiment, performed by using the video decoding apparatus 20 of FIG. 2A.

In operation 211, the subregion receiver 22 extracts from a received bitstream an encoded bit string of encoding symbols that are generated based on blocks of each subregion of a picture.

In operation 213, the subregion entropy decoder 24 may determine initial code probability information to start entropy decoding on a current subregion. The subregion entropy decoder 24 according to an exemplary embodiment may obtain initial code probability information of a start block, from blocks of other subregions that are previously restored. The subregion entropy decoder 24 according to an exemplary embodiment may determine a block to be referred to when determining code probability information of a start block from among boundary blocks of a neighboring subregion, which is restored before the start block and is adjacent to a boundary between a current subregion and the neighboring subregion, from among blocks of the neighboring subregion.

The subregion entropy decoder 24 according to an exemplary embodiment may determine initial code probability information of a start block of a current subregion by using code probability information of the reference block that is determined from the neighboring subregion. The subregion entropy decoder 24 may start entropy encoding on the current subregion based on initial code probability information that is determined from the neighboring subregion.

The subregion entropy decoder 24 according to an exemplary embodiment may determine one of at least one block, located at a position designated based on a position of a start block, as an entropy reference block for determining initial code probability information of a current subregion.

The subregion receiver 22 according to an exemplary embodiment may also parse, from the received bitstream, information indicating a location of a block that is determined as the entropy reference block for the start block of the current subregion, from among boundary blocks of a neighboring subregion of a current subregion.

Information indicating a position of the entropy reference block, according to an exemplary embodiment, may be at least one of information indicating an absolute position of the entropy reference block in a picture, information indicating a scan order of the entropy reference block in a picture, information indicating at least one of distances between a start block of a current subregion and the entropy reference blocks, and index information of the entropy reference block from among indices indicating at least one block adjacent to a position designated based on a position of a start block.

However, the subregion entropy decoder 24 according to another exemplary embodiment may determine a block, from among blocks adjacent to the left or at an upper end of the current start block, as an entropy reference block, even when the subregion receiver 22 according to an exemplary embodiment does not additionally parse information indicating a location of the entropy reference block.

In operation 215, the subregion entropy decoder 24 may perform entropy decoding on a predetermined subregion in parallel with entropy decoding on a current subregion.

For example, even if a current subregion is after a predetermined subregion in a decoding order, entropy decoding of a current subregion may be started by obtaining initial code probability information from a block selected from among boundary blocks of a neighbor block adjacent to the current subregion. Thus, entropy decoding on the current subregion and entropy decoding on the predetermined subregion may be performed in parallel.

In operation 217, the restorer 26 may restore encoding symbols of blocks of a current subregion by performing entropy decoding on the current subregion based on initial code probability information of the start block. Initial code probability information of each block may be renewed by using the encoding symbols that are renewed for each block to thereby finally determine code probability information. Accordingly, as entropy decoding is performed based on the code probability information renewed for each block, the encoding symbols of the blocks may be sequentially restored.

In operation 219, a picture may be restored by performing source decoding on the restored encoding symbols of each subregion.

FIG. 2C is a flowchart of a video decoding method 23 according to another exemplary embodiment, performed by using the video decoding apparatus 20 of FIG. 2A.

In operation 231, the subregion receiver 22 according to another exemplary embodiment extracts from a received bitstream an encoded bit string of encoding symbols that are generated based on blocks for each subregion of a picture.

In operation 233, the subregion entropy decoder 24 according to another exemplary embodiment may extract from the received bit stream entropy reference possibility information indicating whether entropy decoding may be performed on a current subregion by referring to a parsing result of a neighboring subregion. Here, a parsing result may include entropy related information generated when entropy decoding is performed.

In operation 235, when it is determined that entropy decoding may be performed on a current subregion by referring to a parsing result of a neighbor subregion based on entropy reference possibility information, the subregion entropy decoder 24 according to another exemplary embodiment may perform entropy decoding on an encoded bit string of encoding symbols of a current subregion. As a result of performing entropy decoding on the current subregion, the encoding symbols of blocks of the current subregion may be sequentially restored.

In operation 237, the subregion entropy decoder 24 according to another exemplary embodiment may perform entropy decoding on a predetermined subregion in parallel with performing entropy decoding on a current subregion.

As described above with reference to FIG. 2B, the subregion entropy decoder 24 according to another exemplary embodiment may determine an entropy reference block from among boundary blocks of a neighboring subregion that is previously decoded before a current subregion. The subregion entropy decoder 24 according to another exemplary embodiment may sequentially restore encoding symbols of blocks by performing entropy decoding on a current subregion based on initial code probability information that is determined by using code probability information of the entropy reference block.

Accordingly, even if a current subregion is after a predetermined subregion in a decoding order, the subregion entropy decoder 24 according to another exemplary embodiment may start entropy decoding on the current subregion by using code probability information of the entropy reference block, and thus, entropy decoding on the current subregion and entropy decoding on the predetermined subregion may be performed in parallel.

In operation 219, a picture may be restored by performing source decoding on the restored encoding symbols of each subregion.

Also, regardless of whether information of a neighboring subregion may be referred to or not when source decoding is performed, whether neighboring subregions refer to another neighboring subregion for entropy related information may be selectively adjusted when subregions are entropy decoded.

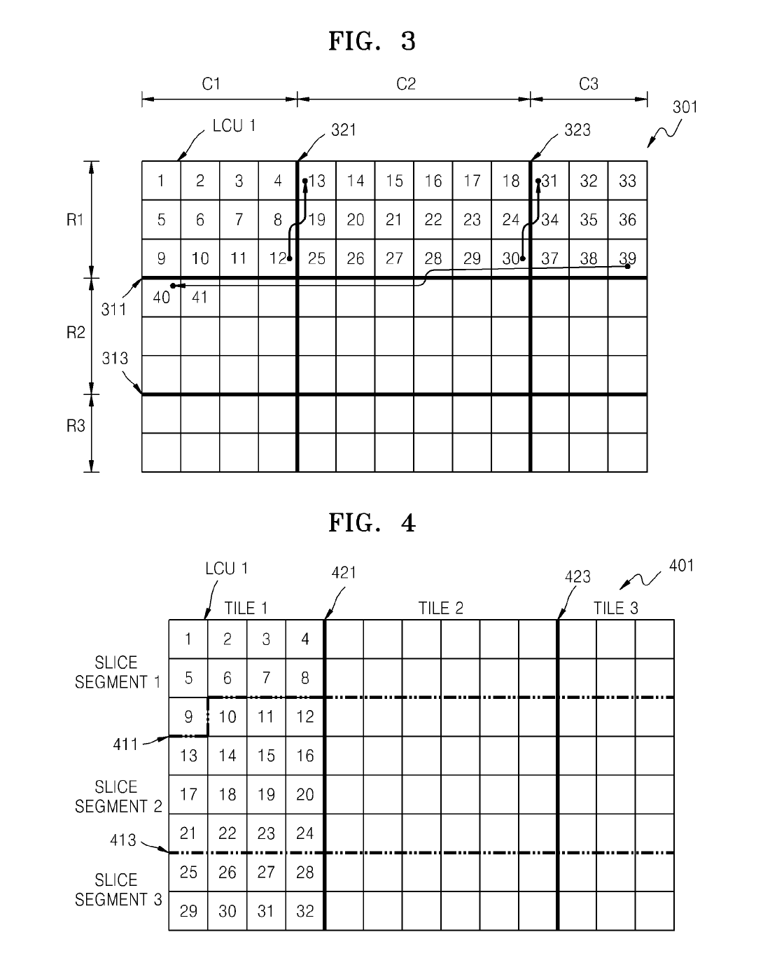

Hereinafter, a structure of a subregion for parallel processing of entropy encoding and entropy decoding according to an exemplary embodiment will be described in detail with reference to FIGS. 3 through 6.

FIG. 3 illustrates tiles.

Each area generated by splitting a picture 301 in a vertical direction and a horizontal direction is referred to as a tile. In order to process, in real-time, a large amount of data of a video having high resolution, such as high definition (HD) or ultra high definition (UHD) video, pictures may be split into at least one column and at least one row to form tiles, and encoding and decoding may be performed on each tile.

Each tile of a picture 301 is an individual spatial domain, and thus only tiles of an area to be encoded or decoded may be selectively encoded or decoded.

In FIG. 3, column boundaries 321 and 323 and row boundaries 311 and 313 may divide the picture 301 according to columns C1, C2, and C3 and rows R1, R2, and R3. Tiles refer to areas each surrounded by one of the column boundaries 321 and 323 and one of the row boundaries 321 and 323.

When encoding the picture 301 by splitting the same into tiles, information about positions of the column boundaries 321 and 323 and the row boundaries 311 and 313 may be included in a sequence parameter set (SPS) or a picture parameter set (PPS) to be transmitted. When decoding the picture 301, information about the positions of the column boundaries 321 and 323 and the row boundaries 311 and 313 may be parsed from the SPS or the PPS to decode each of the tiles, thereby restoring each of subregions of the picture 301. Each of the subregions may be restored to the one picture 301 by using information about the column boundaries 321 and 323 and row boundaries 311 and 313.

The picture 301 is split into maximum coding units (also referred to as largest coding units, or LCUs), and encoding and decoding are performed for each block. Accordingly, each of the tiles formed by splitting the picture 301 by the column boundaries 321 and 323 and the row boundaries 311 and 313 may include LCUs. The column boundaries 321 and 323 and the row boundaries 311 and 313 pass along boundaries of adjacent LCUs, and thus do not split the LCUs. Accordingly, each tile may include an integer number of LCUs.

Thus, as processing is performed on each tile of the picture 301, encoding and decoding may be performed on each LCU in each tile.

A tile may be classified as a dependent tile or an independent tile. For a dependent tile, information that is used or generated in source coding and entropy encoding regarding a predetermined tile may be referred to for source coding or entropy encoding of another tile. For decoding, also, parsing information used in entropy decoding performed on a predetermined tile from among dependent tiles or information used or restored in source decoding may be referred to for entropy decoding or source decoding of another tile.

For an independent tile, information that is used or generated in source coding or entropy encoding is not referred to between tiles, and each independent tile is independently encoded. For decoding, parsing information used in entropy decoding performed on a predetermined tile from among dependent tiles or information used or restored in source decoding is not used at all for entropy decoding or source decoding of another tile.

Information about whether a tile type is a dependent tile or an independent tile may be included in an SPS or PPS to be transmitted. When decoding the picture 301, information about a tile type may be parsed from an SPS or PPS to restore by referring to tiles according to the tile type or may be independently decoded for each tile.

An independent tile may be similar to a slice segment in that encoding and decoding on tiles are independently performed. An independent tile and a slice segment will be compared below with reference to FIG. 4.

FIG. 4 illustrates differences between tiles and slice segments.

While FIG. 3 illustrates the tiles formed by splitting the picture 301 according to the column boundaries 321 and 323 and the row boundaries 311 and 313, tiles that are split only along columns, as illustrated in FIG. 4, are also possible. A picture 401 is split by two column boundaries 421 and 423 to form three tiles, Tile 1, Tile 2, and Tile 3. Also, the picture 410 may be split by two row boundaries 411 and 413 to form three slice segments, Slice Segment 1, Slice Segment 2, and Slice Segment 3.

That is, while slice segments are formed by splitting the picture 401 only horizontally, tiles may be formed by splitting the picture 301 vertically.

For slice segments, partial images that are horizontally relatively long are independently encoded or decoded with respect to one another. On the other hand, as tiles may be formed by splitting the picture 401 not only horizontally but also vertically, if partial images of the picture 401 are to be encoded and decoded, partial images that are partitioned into segments and various sizes may be individually encoded or decoded.

Encoding and decoding of a dependent tile will be described by referring to FIG. 3 again. Hereinafter, for convenience of description, an index of a tile at a point where one of the columns C1, C2, and C3 and one of the rows R1, R2, and R3 contact is marked by using a column index and a row index. For example, a tile at a point where the column C1 and the row R3 overlap is marked as a tile C1R3. The number marked on each LCU refers to an encoding order (or decoding order) of a current LCU from among the LCUs.

Tiles may each be encoded or decoded. In video encoding or video decoding by using a single core processor, one processing core is only able to process one process regarding a tile at a time. Accordingly, tiles may be sequentially encoded or decoded according to a raster scan order, in an order of tiles C1R1, C2R1, C3R1, C1R2, . . . . Also, among the tiles C1R1, C2R1, C3R1, C1R2, . . . , which are dependent tiles, a current tile may be encoded or decoded by referring to information of a tile that is encoded or restored before the current tile.

For example, in entropy encoding according to context-based arithmetic coding or entropy decoding corresponding thereto, context-based code probability information may be renewed for each LCU.

However, as entropy encoding and decoding performed on tile C1R1 is completed at LCU No. 12, the process has to start from LCU No. 13 for entropy encoding and decoding on a next tile C2R1. Here, initial code probability information for entropy encoding and decoding of LCU No. 13 is code probability information of LCU No. 12 that is processed immediately before.

Likewise, when entropy encoding and decoding of LCU No. 13 to LCU No. 30 in tile C2R1 are completed, initial code probability information of LCU No. 31 is determined as code probability information of LCU No. 30 in order to start entropy encoding and decoding of tile C3R1. Also when an object of entropy encoding and decoding is converted from the tile C3R1 to the tile C1R2, initial code probability information of LCU No. 40 is determined as code probability information of LCU No. 39.

However, according to the entropy encoding and decoding methods as described above, if a sufficient delay time between processing periods is not provided such as in a low latency application, entropy encoding and decoding processing may not be performed on an LCU string formed of LCUs that are arranged along one horizontal row line, at a time.

For example, a first LCU string is formed of LCUs Nos. 1 to 4, LCUs Nos. 13-18, and LCUs No. 31-33, according to an encoding order.

When performing encoding or decoding on the first LCU string in the picture 301 having a tile structure, information of LCU No. 12 of tile C1R1 may be referred to by LCU No. 13 of tile C2R1, and information of LCU No. 30 of tile C2R1 may be referred to by LCU No. 31 of tile C3R1.

However, in encoding and decoding via a low latency application, even when processing on LCU No. 4 of a first LCU string is completed, since a process up to LCU No. 12 has not been conducted yet, initial information of LCU No. 13 is not promptly secured. Likewise, even when processing on LCU No. 4 of a first LCU string is completed, initial information for LCU No. 31 may not be secured. Accordingly, for a low latency application, encoding or decoding processing on an LCU string may not be performed at a time in the picture 301 having a tile structure.

Also, for encoding and decoding of a dependent tile, a dependent tile that is adjacent to another dependent tile, the dependent tile may refer to some encoding information of the other dependent tile. For example, for encoding and decoding of LCUs Nos. 13, 19, and 25 of tile C2R1, encoding information of LCUs Nos. 4, 8, and 12 of tile C1R1 may be referred to. Encoding information being referred to may be a restoration pixel, a motion vector, or the like.

When video encoding or decoding is performed via a single core application, tile C2R1 may be processed after encoding or decoding LCUs of tile C1R1 according to a raster scan order. Thus, an additional column buffer for storing encoding information of LCUs Nos. 4, 8, and 12 of tile C1R1 which tile C2R1 may refer to is required. Likewise, a column buffer for storing encoding information of LCUs Nos. 18, 24, and 30 of tile C2R1 is required. That is, an additional column buffer is required to store a part of encoding information of LCUs that are adjacent to the left of the column boundaries 321 and 323 between the tiles.

Also, when performing video encoding or decoding via a multicore application, each processing core in the multicore application may be assigned to a tile. For example, a first processing core may perform a video encoding or decoding process on tile C1R1, a second processing core may perform a video encoding or decoding process on tile C2R1, and a third processing core may perform a video encoding or decoding process for tile C3R1. However, for video encoding or decoding of LCU No. 13 of tile C2R1, encoding information of tile C1R1 is needed as reference information, and thus, the second processing core may not perform a video encoding or decoding process on tile C2R1 until reference information is obtained. Likewise, the third processing core may not simultaneously perform a video encoding or decoding process on tile C3R1 with the video encoding or decoding process performed on tile C2R1 by the second processing core. Accordingly, even a multicore application may not perform an encoding or decoding process on tiles C1R1, C2R1, and C3R1 in parallel.

Accordingly, hereinafter, a method of performing entropy encoding for video encoding by using the video encoding apparatus 10 according to an exemplary embodiment by parallel processing, and a method of performing entropy decoding for video decoding by using the video decoding apparatus 20 by parallel processing are provided.

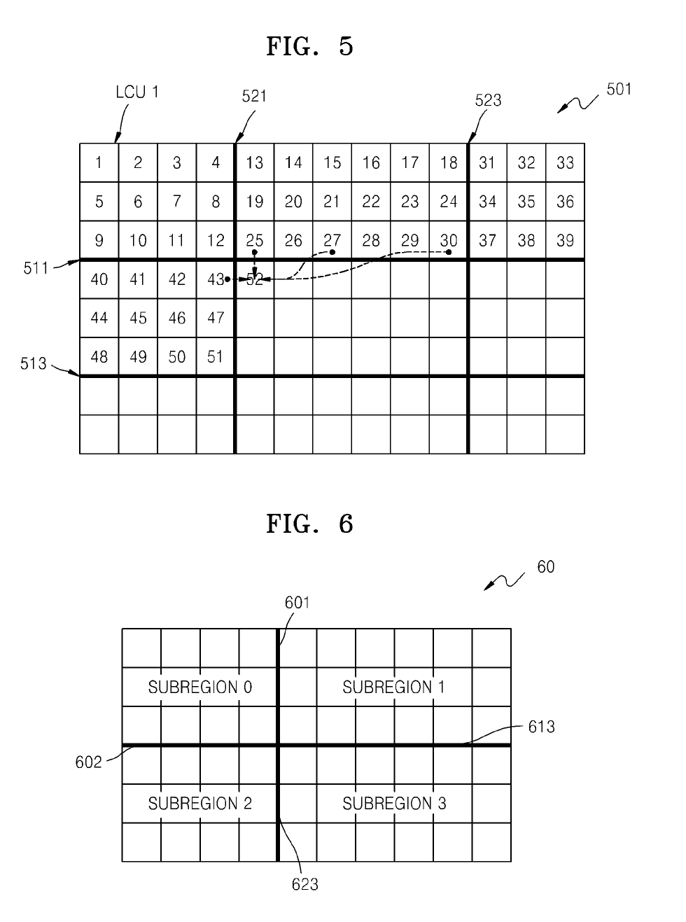

FIG. 5 illustrates reference objects for determining initial code probability information in a subregion according to an exemplary embodiment.

A subregion according to an exemplary embodiment is formed by splitting a picture 501 by column boundaries 521 and 523 and row boundaries 511 and 513. A subregion according to an exemplary embodiment may be a tile or another type of data unit.

In order for the video encoding apparatus 10 according to an exemplary embodiment to perform context-based arithmetic coding on LCU No. 52, from among LCUs of neighboring subregions, one of the LCUs Nos. 25, 26, 27, 28, 29, 30, and 43 that are adjacent to the column boundary 521 and the row boundary 511 and are encoded before a current LCU is selected, and code probability information may be obtained from the selected LCU.

The obtained code probability information may be code probability information of the selected LCU or may be code probability information of a predetermined coding unit adjacent to the column and row boundaries 521 and 511 from among coding units included in the selected LCU. Accordingly, an LCU or coding unit that is selected to obtain code probability information is referred to as a reference block below.

The video encoding apparatus 10 according to an exemplary embodiment may determine a reference block by selecting one of the LCUs from among LCUs Nos. 25, 26, 27, 28, 29, 30, and 43 of neighboring subregions that are encoded before a current LCU, LCU No. 52, and are adjacent to LCU No. 52.

Also, the video encoding apparatus 10 according to an exemplary embodiment may determine at least two candidate blocks from among LCUs Nos. 25, 26, 27, 28, 29, 30, 43, 47, and 51 according to a location of LCU No. 52, and may finally select a reference block from among the candidate blocks. For example, only blocks adjacent at an upper end of LCU No. 52 may be candidate blocks, or blocks adjacent on the left of LCU No. 52 may be candidate blocks, or both blocks adjacent at an upper end and on the left may all be candidate blocks. Alternatively, only blocks that are designated and adjacent to LCU No. 52 may be candidate blocks.

Also, as a candidate block, instead of an actual block being added, a table including default code probability information may be added. That is, if a candidate block which is a table is determined, code probability information of neighbor blocks is not inherited, and initial code probability information of LCU No. 52 may be determined by using default code probability information included in the table.

The video encoding apparatus 10 according to an exemplary embodiment may determine code probability information of LCU No. 52 by referring to code probability information of the selected reference block.

When a reference block is selected as described above, the video encoding apparatus 10 according to an exemplary embodiment may encode information indicating a location of the selected reference block.

For example, information indicating an absolute address or location of the selected reference block may be encoded. Coordinate information whereby an address of a reference block is expressed by coordinates such as (x, y) may be encoded, or information about a horizontal address or information about a vertical address may be individually encoded. For transmission efficiency, information indicating an address or a location of a reference block may be encoded as information regarding a distance between the reference block and a current LCU, for example, information indicating a position difference such as (dx, dy).

Alternatively, information indicating an encoding order index of a reference block according to a raster scan order may be encoded. For transmission efficiency, information about a difference between an index of a currently selected reference block and an index that is previously used may be encoded.

If an optimum reference block is selected from among candidate blocks surrounding a current LCU, information indicating an index of the selected reference block from among indices indicating candidate blocks may be encoded.

According to another example of determining a reference block, if there is a subregion that is on the left of LCU No. 52 and is encoded before LCU No. 52, an LCU or a coding unit that is closest to LCU No. 52 from among subregions on the left of LCU No. 52 may be determined as a reference block. Similarly, if there is a subregion that is above LCU No. 52 and is encoded before LCU No. 52, an LCU or coding unit that is closest to LCU No. 52 from among upper subregions may be determined as a reference block. If there are previously encoded subregions both on the left and above LCU No. 52, an LCU or coding unit that is located in a direction in which parallel processing of entropy encoding is easy may be determined as a reference block. When a reference block is determined according to this other example of determining a reference block, information indicating a reference block may not have to be additionally encoded.

The video encoding apparatus 10 according to an exemplary embodiment may determine initial code probability information of the current LCU, LCU No. 52, based on code probability information of the determined reference block by using the above-described various methods. The video encoding apparatus 10 may sequentially entropy encode blocks in a subregion, starting from LCU No. 52.

Accordingly, the video encoding apparatus 10 according to an exemplary embodiment may obtain initial code probability information of a first LCU for each subregion, based on code probability information of a reference block that is previously encoded and already stored, and thus, entropy encoding on respective adjacent subregions may be performed in parallel. Also, processing on an LCU string may be performed at a time without interruption.

The video decoding apparatus 20 according to an exemplary embodiment operates in the same manner as above. The video decoding apparatus 20 requires initial code probability information of LCU No. 52 in order to decode a subregion that includes LCU No. 52.

The video decoding apparatus 20 may determine one of LCUs Nos. 25, 26, 27, 28, 29, 30, and 43 of neighboring subregions that are encoded before LCU No. 52 and are adjacent to LCU No. 52, as a reference block.

The video decoding apparatus 20 according to an exemplary embodiment may receive information indicating a location of a reference block to determine initial code probability information of LCU No. 52.

For example, information indicating an absolute address or location of the selected reference block may be extracted. Coordinates information whereby an address of a reference block is expressed by coordinates such as (x, y) may be encoded, or information about a horizontal address and information about a vertical address may be individually encoded. For transmission efficiency, information indicating an address or location of a reference block may be encoded as information regarding a distance between the reference block and a current LCU, for example, information indicating a position difference such as (dx, dy). In this case, the location of LCU No. 52 and information indicating a position difference may be combined to determine a location of the reference block.

Alternatively, information indicating an encoding order index of a reference block according to a raster scan order may be received. Information indicating a difference between indices of a currently selected reference block and a previously used reference block may also be received. In this case, the information indicating the difference between the received index and the index of the previously used reference block may be combined to determine an index of a reference block.

Alternatively, from among indices that indicate candidate blocks surrounding the current LCU, information indicating the index of the selected reference block may be received.

For example, if at least two candidate blocks are determined from among LCUs Nos. 25, 26, 27, 28, 29, 30, 43, 47, and 51 according to a location of LCU No. 52, a reference block may be selected from among the candidate blocks. For example, only blocks adjacent to and above LCU No. 52 may be candidate blocks, or blocks adjacent to and on the left of LCU No. 52 may be candidate blocks, or both blocks adjacent to and above and blocks adjacent to and on the left of LCU No. 52 may all be candidate blocks. Alternatively, blocks that are designated and adjacent to LCU No. 52 may be candidate blocks.

Also, as a candidate block, instead of an actual block being added, a table including default code probability information may be added. That is, if a candidate block which is a table is determined, code probability information of neighbor blocks is not inherited and initial code probability information of LCU No. 52 may be determined by using default code probability information included in the table.

From among candidate blocks determined in the above-described manner, code probability information of a block or table indicated by index information may be determined as reference information.

Also, as another example of determining a reference block, if there is a set rule between the video encoding apparatus 10 and the video decoding apparatus 20, even if the video decoding apparatus 20 does not receive information indicating a location of the reference block, the video decoding apparatus 20 may determine a location of the reference block according to a location of the current LCU, LCU No. 52.

For example, if there is a subregion that is on the left of LCU No. 52 and is encoded before LCU No. 52, an LCU or a coding unit that is closest to LCU No. 52 from among subregions on the left of LCU No. 52 may be determined as a reference block. Similarly, if there is a subregion that is above LCU No. 52 and is encoded before LCU No. 52, an LCU or coding unit that is closest to LCU No. 52 from among upper subregions may be determined as a reference block. If there are previously encoded subregions both on the left and above LCU No. 52, an LCU or coding unit that is located in a direction in which parallel processing of entropy decoding is easy may be determined as a reference block. If a reference block is determined according to this other example of determining a reference block, information indicating a reference block may not have to be additionally encoded.

Accordingly, the video decoding apparatus 20 may determine initial code probability information of the current LCU, LCU No. 52, based on code probability information of the reference block determined according to the above-described various methods, and may sequentially perform entropy decoding on blocks in a subregion, starting from the current LCU, LCU No. 52.

Thus, the video decoding apparatus 20 according to an exemplary embodiment may obtain initial code probability information of a first LCU for each subregion, based on code probability information of a reference block that is previously encoded and already stored, and thus, entropy decoding on respective adjacent subregions may be performed in parallel. Also, processing on an LCU string may be performed at a time without interruption.

FIG. 6 illustrates a parsing reference possibility between subregions according to an exemplary embodiment.

When performing source coding and entropy encoding on a dependent tile, previously processed neighbor tiles may be referred to, and also, neighbor tiles that are previously processed when performing parsing and source decoding may be referred to. When performing source coding and entropy encoding on an independent tile, neighbor tiles that are previously processed when performing parsing and source decoding may be referred to.

The video encoding apparatus 10 according to an exemplary embodiment may determine whether a last piece of entropy related information of a neighboring subregion that is previously encoded is either inherited or not inherited, when performing entropy encoding on a subregion. That is, regardless of whether a neighboring subregion may be referred to or not during the source coding of a subregion, whether the subregion refers to a neighboring subregion for entropy related information only in entropy encoding may be adjusted.

Inheritable entropy related information may be, for example, code probability information, a context mode, or bin information.

Similarly, regardless of whether a neighboring subregion may be referred to or not in source decoding of a subregion, the video decoding apparatus 20 according to an exemplary embodiment may determine whether a last piece of entropy related information of a neighboring subregion that is previously parsed when performing entropy decoding of a subregion is either referred to and inherited or not referred to.

Referring to FIG. 6, a picture 60 is split by column boundaries 601 and 623 and row boundaries 602 and 613 and includes subregions 0, 1, 2, and 3.

The video encoding apparatus 10 according to an exemplary embodiment may encode entropy reference possibility information indicating whether entropy encoding is performed by referring to entropy related information of a neighboring subregion, for each subregion. In FIG. 6, ‘Dec_flag’ which is 1 bit in length and has a value of 0 or 1 may be used as entropy reference possibility information.

The video encoding apparatus 10 according to an exemplary embodiment independently performs entropy encoding on subregion 0 without referring to entropy related information of a neighboring subregion. Accordingly, the video encoding apparatus 10 may set reference possibility information (Dec_flag) for subregion 0, to 0.

The video encoding apparatus 10 according to an exemplary embodiment performs entropy encoding on subregion 1 by referring to entropy related information of subregion 0 that is adjacent to subregion 1. Accordingly, the video encoding apparatus 10 may set reference possibility information Dec_flag for subregion 1, to 1.

The video encoding apparatus 10 according to an exemplary embodiment performs entropy encoding on subregion 2 without referring to entropy related information of a neighboring subregion with respect to subregion 2, and may set reference possibility information (Dec_flag) for subregion 2, to 0.

The video encoding apparatus 10 according to an exemplary embodiment performs entropy encoding on subregion 3 by referring to entropy related information of subregion 1 adjacent to subregion 3, and may set reference possibility information (Dec_flag) for subregion 3, to 1.

The video encoding apparatus 10 according to an exemplary embodiment may initialize initial code probability information when starting entropy encoding for each subregion. However, the value to which initial code probability information is initialized may be determined using the method described above with reference to FIG. 5. That is, initial code probability information to be used in entropy encoding performed on a current first LCU of a subregion may be obtained from a reference block that is selected from among blocks of a neighboring subregion surrounding the current LCU.

In a manner similar to that of the video encoding apparatus 10 described above, the video decoding apparatus 20 according to an exemplary embodiment may receive entropy reference possibility information indicating whether entropy decoding is performed by referring to a parsing result of a neighboring subregion, for each subregion.

When the video decoding apparatus 20 according to an exemplary embodiment determines that reference possibility information (Dec_flag) for subregion 0 is 0, the video decoding apparatus 20 may independently perform entropy decoding without referring to a parsing result of a neighboring subregion, that is, entropy related information.

When the video decoding apparatus 20 according to an exemplary embodiment determines that reference possibility information (Dec_flag) for subregion 1 is 1, the video decoding apparatus 20 may perform entropy decoding by referring to a parsing result of subregion 0 that is adjacent to subregion 1.

The video decoding apparatus 20 according to an exemplary embodiment may determine that reference possibility information (Dec_flag) for subregion 2 is 0, and may independently perform entropy decoding without referring to a parsing result of a neighboring subregion.

The video decoding apparatus 20 according to an exemplary embodiment may determine that reference possibility information (Dec_flag) for subregion 3 is 1, and may independently perform entropy decoding by referring to a parsing result of subregion 1 that is adjacent to subregion 3.

Also, when starting entropy decoding on each subregion, as described above with reference to FIG. 5, initial code probability information to be used in entropy encoding performed on a current first LCU of a subregion, is obtained from a reference block that is determined from among blocks of a neighboring subregion which surround the current LCU.

A subregion according to an exemplary embodiment is a region that is formed by splitting a picture not only in a horizontal direction but also in a vertical direction, and thus, each subregion has a smaller data amount to be parsed and stored than a slice segment that is formed by splitting a picture only in a horizontal direction. Accordingly, it is easy to perform entropy decoding on multiple subregions in parallel, and then to perform source decoding on each subregion.

Also, as initial code probability information for each subregion is initialized as a pre-stored value to later be obtained, a delay time of a standby state when obtaining the initial code probability information may be minimized, and entropy related information of other blocks to be stored in advance may also be minimized. Accordingly, entropy decoding may be performed on multiple subregions in parallel. This effect may also be obtained in the video decoding apparatus 10 that uses an entropy encoding method according to an exemplary embodiment.

In the video encoding apparatus 10 according to an exemplary embodiment and the video decoding apparatus 20 according to an exemplary embodiment, blocks obtained by splitting video data are LCUs, and each LCU is split into coding units according to a tree structure, as described above. A method and apparatus for video encoding based on coding units according to a tree structure, according to an exemplary embodiment, and a method and apparatus for video decoding will be described below with reference to FIGS. 7 through 19.

FIG. 7 is a block diagram of a video encoding apparatus 100 based on a coding unit according to a tree structure, according to an exemplary embodiment.

The video encoding apparatus 100 via video prediction based on a coding unit according to a tree structure includes a coding unit determiner 120 and an output unit 130. Hereinafter, for convenience of description, the video encoding apparatus 100 via video prediction based on a coding unit according to a tree structure may also be referred to as ‘the video encoding apparatus 100’.

The coding unit determiner 120 may divide a current picture based on an LCU, which is a coding unit having a largest size regarding a current picture of an image. If a current picture is larger than an LCU, image data of the current picture may be split into at least one LCU. The LCU according to an exemplary embodiment may be a data unit having a size of 32×32 pixels, 64×64, 128×128, 256×256, etc., wherein a shape of the data unit is a square having a width and length in squares of 2.

A coding unit according to an exemplary embodiment may be characterized by a maximum size and a depth. The depth denotes a number of times the coding unit is spatially split from the maximum coding unit, and as the depth deepens, deeper encoding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit deepens, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split, may be predetermined.

The coding unit determiner 120 encodes at least one split region obtained by splitting a region of the maximum coding unit according to depths, and determines a depth to output a finally encoded image data according to the at least one split region. In other words, the coding unit determiner 120 determines a coded depth by encoding the image data in the deeper coding units according to depths, according to the maximum coding unit of the current picture, and selecting a depth having the least encoding error. Thus, the encoded image data of the coding unit corresponding to the determined coded depth is finally output. Also, the coding units corresponding to the coded depth may be regarded as encoded coding units. The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Also, even if coding units correspond to the same depth in one maximum coding unit, it is determined whether to split each of the coding units corresponding to the same depth to a lower depth by measuring an encoding error of the image data of each of the coding units, separately. Accordingly, even when image data is included in one maximum coding unit, the image data is split into regions according to the depths and the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of times splitting is performed from a maximum coding unit to a minimum coding unit. A first maximum depth according to an exemplary embodiment may denote the total number of times splitting is performed from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3 and 4 exist, and thus the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit. Transformation may be performed according to a method of orthogonal transformation or integer transformation.

Since the number of deeper coding units increases whenever the maximum coding unit is split according to depths, encoding including the prediction encoding and the transformation is performed on all of the deeper coding units generated as the depth deepens. For convenience of description, the prediction encoding and the transformation will now be described based on a coding unit of a current depth, in a maximum coding unit.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding on the maximum coding unit, the prediction encoding may be performed based on a coding unit corresponding to a coded depth, e.g., based on a coding unit that is no longer split into coding units corresponding to a lower depth. Hereinafter, the coding unit that is no longer split and becomes a basis unit for prediction encoding may also be referred to as a ‘prediction unit’. A partition obtained by splitting the prediction unit may include a prediction unit or a data unit obtained by splitting at least one of a height and a width of the prediction unit. The partition is a data unit obtained by dividing the prediction unit of the coding unit and the prediction unit may be a partition having the same size as the coding unit.

For example, when a coding unit of 2N×2N (where N is a positive integer) is no longer split and becomes a prediction unit of 2N×2N, a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, an inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a transformation unit that is different from the coding unit. In order to perform the transformation in the coding unit, the transformation may be performed based on a data unit having a size smaller than or equal to the coding unit. For example, the transformation unit for the transformation may include a transformation unit for an intra mode and a data unit for an inter mode.

Similarly to the coding unit according to the tree structure according to the present exemplary embodiment, the transformation unit in the coding unit may be recursively split into smaller sized regions and residual data in the coding unit may be divided according to the transformation having the tree structure according to transformation depths.

According to an exemplary embodiment, a transformation depth indicating the number of times splitting is performed to reach the transformation unit by splitting the height and width of the coding unit may also be set in the transformation unit. For example, when the size of a transformation unit of a current coding unit is 2N×2N, a transformation depth may be set to 0. When the size of a transformation unit is N×N, the transformation depth may be set to 1. In addition, when the size of the transformation unit is N/2×N/2, the transformation depth may be set to 2. That is, the transformation unit according to the tree structure may also be set according to the transformation depth.

Encoding information according to coding units corresponding to a coded depth requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

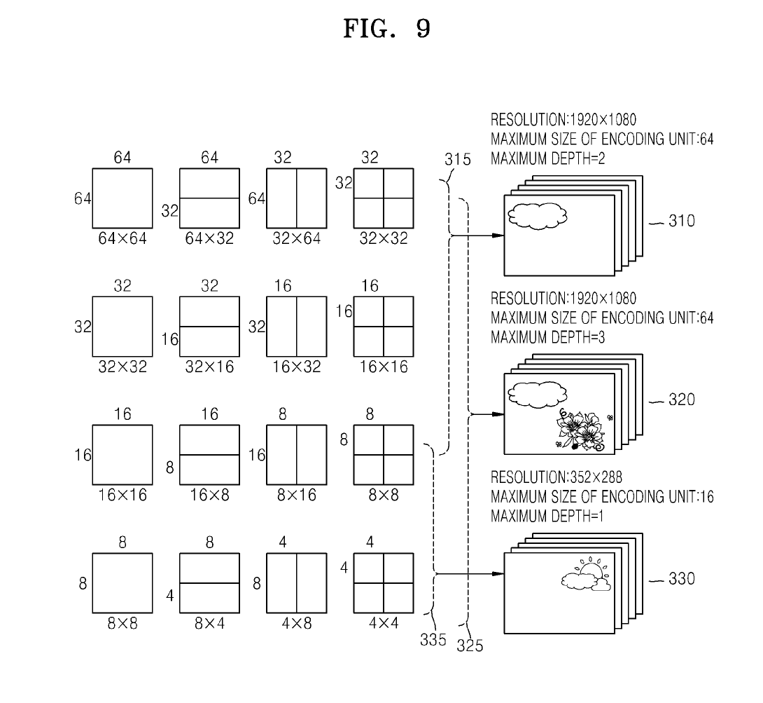

Coding units and a prediction unit/partition according to a tree structure in a maximum coding unit, and a method of determining a transformation unit, according to exemplary embodiments, will be described in detail later with reference to FIGS. 9 through 19.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to the coded depth may include information about the coded depth, the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus, the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus, the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations since the image data is hierarchically split according to depths, and thus, information about the coded depth and the encoding mode may be set for the image data.

Accordingly, the output unit 130 may assign encoding information about a corresponding coded depth and an encoding mode to at least one of the coding unit, the prediction unit, and a minimum unit included in the maximum coding unit.

The minimum unit according to an exemplary embodiment is a square data unit obtained by splitting the minimum coding unit constituting the lowermost depth by 4. Alternatively, the minimum unit may be a maximum rectangular data unit having a maximum size, which is included in all of the coding units, prediction units, partition units, and transformation units included in the maximum coding unit.

For example, the encoding information output through the output unit 130 may be classified into encoding information according to coding units, and encoding information according to prediction units. The encoding information according to the coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Also, information about a maximum size of the coding unit defined according to pictures, slices, or GOPs, and information about a maximum depth may be inserted into a header of a bitstream, an SPS or a PPS.

In addition, information about a maximum size of a transformation unit and information about a minimum size of a transformation unit, which are acceptable for a current video, may also be output via a header of a bitstream, an SPS or a PPS. The output unit 130 may encode and output reference information, prediction information, slice segment type information or the like.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include a maximum value 4 of the coding unit of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

Thus, if an image having high resolution or a large data amount is encoded in a related art macroblock, a number of macroblocks per picture excessively increases. Accordingly, a number of pieces of compressed information generated for each macroblock increases, and thus, it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

Hereinafter, the entropy encoding method and the video encoding method according to exemplary embodiments described above with reference to FIGS. 1A, 1B, and 1C, as performed by the video encoding apparatus 100 according to an exemplary embodiment, will be described in detail.

As a result of determining coding units according to a tree structure for each LCU, and performing encoding on each coding unit by using the video encoding apparatus 100 according to an exemplary embodiment, symbols are generated. The video encoding apparatus 100 may perform encoding on each subregion that is formed by splitting a picture in a vertical direction. Encoding symbols may be generated by performing source coding on LCUs of each subregion.

The video encoding apparatus 100 according to an exemplary embodiment may determine entropy reference blocks from among boundary blocks of a neighboring subregion that is encoded before a start block of a current subregion. The video encoding apparatus 100 according to an exemplary embodiment may sequentially perform entropy encoding on each block of a current subregion, starting from a start block, based on code probability information of the start block that is determined by using code probability information of the entropy reference block.

The video encoding apparatus 100 according to an exemplary embodiment may determine whether entropy encoding on a current subregion is possible, by referring to blocks of a neighboring subregion. If possible, entropy encoding on a current subregion may be performed by referring to a neighboring subregion. For example, entropy related information of the current subregion may be determined by referring to neighboring subregions. For example, entropy related information of a current subregion may be determined by referring to entropy related information that is determined when a neighboring subregion is entropy encoded.

The video encoding apparatus 100 according to an exemplary embodiment may output entropy reference possibility information indicating that entropy encoding may be performed on a current subregion by referring to a neighboring subregion.

The video encoding apparatus 100 according to an exemplary embodiment may perform entropy encoding on a predetermined subregion from among subregions, in parallel with performing entropy encoding on a current subregion. Even though the current subregion is after a predetermined subregion in an encoding order, the video encoding apparatus 100 according to an exemplary embodiment may start entropy encoding on a current subregion by using code probability information of an entropy reference block, and thus, entropy encoding on a current subregion and entropy encoding on a predetermined subregion may be performed in parallel.

FIG. 8 is a block diagram of a video decoding apparatus 200 based on a coding unit according to a tree structure, according to an exemplary embodiment.

The video decoding apparatus 200 based on the coding unit according to the tree structure includes a receiver 210, an image data and encoding information extractor 220, and an image data decoder 230. Hereinafter, for convenience of description, the video decoding apparatus 200 using video prediction based on a coding unit according to a tree structure will be referred to as the ‘video decoding apparatus 200’.

Definitions of various terms, such as a coding unit, a depth, a prediction unit, a transformation unit, and information about various encoding modes, for decoding operations of the video decoding apparatus 200, may be identical to those described with reference to FIG. 7 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture, an SPS, or a PPS.

Also, the image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. The predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse transformation. Inverse transformation may be performed according to a method of inverse orthogonal transformation or inverse integer transformation.

The image data decoder 230 may perform intra prediction or motion compensation according to a partition and a prediction mode of each coding unit, based on the information about the partition type and the prediction mode of the prediction unit of the coding unit according to coded depths.

In addition, the image data decoder 230 may read transformation unit information according to a tree structure for each coding unit so as to determine transform units for each coding unit and perform inverse transformation based on a transformation unit for each coding unit, for inverse transformation for each maximum coding unit. Via the inverse transformation, a pixel value of a spatial region of the coding unit may be restored.

The image data decoder 230 may determine at least one coded depth of a current maximum coding unit by using split information according to depths. If the split information indicates that image data is no longer split in the current depth, the current depth is a coded depth. Accordingly, the image data decoder 230 may decode encoded data of at least one coding unit corresponding to each coded depth in the current maximum coding unit by using the information about the partition type of the prediction unit, the prediction mode, and the size of the transformation unit for each coding unit corresponding to the coded depth, and output the image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. For each coding unit determined as described above, information about an encoding mode may be obtained so as to decode the current coding unit.

The entropy decoding method and the video decoding method described above with reference to FIGS. 2A, 2B, and 2C may be applied to the receiver 210. The entropy decoding apparatus 20 may parse from a received bitstream a plurality of subregions that are formed by splitting a picture in a vertical direction. For each subregion, encoded bit strings of encoding symbols generated based on LCUs may be extracted.

The receiver 210 may extract from the received bitstream entropy reference possibility information indicating whether entropy decoding may be performed on a current subregion by referring to a parsing result of a neighboring subregion. Here, a parsing result may include entropy related information generated during entropy decoding.

When it is determined that entropy decoding on a current subregion may be performed by referring to a parsing result of a neighboring subregion, based on the entropy reference possibility information, the receiver 210 may perform entropy decoding on an encoded bit string of encoding symbols of the current subregion, by referring to data that is generated as a result of parsing the neighbor region. As a result of entropy decoding performed on the current subregion, encoding symbols of blocks of the current subregion may be sequentially restored.

The receiver 210 may determine entropy reference blocks from among boundary blocks of a neighboring subregion that is encoded before a current subregion. The receiver 210 may perform entropy decoding on a current subregion to sequentially restore encoding symbols of blocks, based on initial code probability information that is determined by using code probability information of the entropy reference block.

Accordingly, even if a current subregion is after a predetermined subregion in a decoding order, the receiver 210 may start entropy decoding on a current subregion by using code probability information of the entropy reference block, and thus, entropy decoding performed on a current subregion and entropy decoding performed on a predetermined subregion may be performed in parallel.

The image data decoder 230 may perform source decoding on the restored encoding symbols of each subregion, and the picture consisting of the restored subregions may be restored.

The video decoding apparatus 200 may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded. Also, the maximum size of a coding unit is determined considering resolution and an amount of image data.

Accordingly, even if image data has a high resolution and a large amount of data, the image data may be efficiently decoded and restored by using a size of a coding unit and an encoding mode, which are adaptively determined according to characteristics of the image data, by using information about an optimum encoding mode received from an encoder.

FIG. 9 is a diagram for describing a concept of coding units according to an exemplary embodiment.

A size of a coding unit may be expressed in width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 9 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the video data 310 may include a maximum coding unit having a long axis size of 64, and coding units having long axis sizes of 32 and 16 since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are deepened to 3 layers by splitting the maximum coding unit three times. As a depth deepens, detailed information may be precisely expressed.

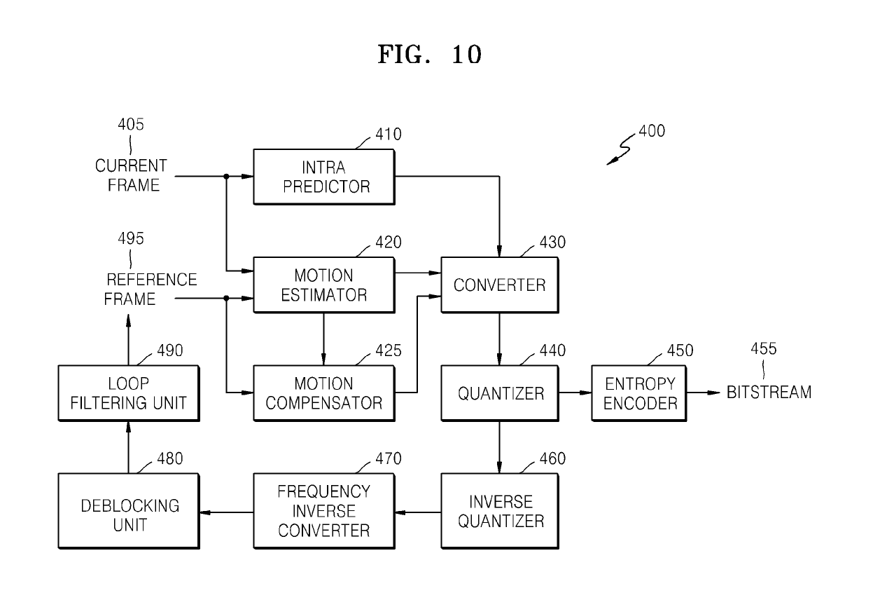

FIG. 10 is a block diagram of an image encoder 400 based on coding units, according to an exemplary embodiment.

The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 performs inter estimation and motion compensation on coding units in an inter mode from among the current frame 405 by using the current frame 405, and a reference frame 495.

Data output from the intra predictor 410, the motion estimator 420, and the motion compensator 425 is output as a quantized transformation coefficient through a converter 430 (e.g., transformer) and a quantizer 440. The quantized transformation coefficient is restored as data in a spatial domain through an inverse quantizer 460 and a frequency inverse converter 470 (e.g., inverse transformer), and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be implemented in the video encoding apparatus 100, all elements of the image encoder 400, e.g., the intra predictor 410, the motion estimator 420, the motion compensator 425, the converter 430, the quantizer 440, the entropy encoder 450, the inverse quantizer 460, the frequency inverse converter 470, the deblocking unit 480, and the loop filtering unit 490 perform operations based on each coding unit from among coding units having a tree structure while considering the maximum depth of each maximum coding unit.

Specifically, the intra predictor 410, the motion estimator 420, and the motion compensator 425 determine partitions and a prediction mode of each coding unit from among the coding units having a tree structure while considering the maximum size and the maximum depth of a current maximum coding unit, and the converter 430 determines the size of the transformation unit in each coding unit from among the coding units having a tree structure.

In particular, the entropy encoder 450 may correspond to the subregion entropy encoder 14 of the video encoding apparatus 10 according to an exemplary embodiment.

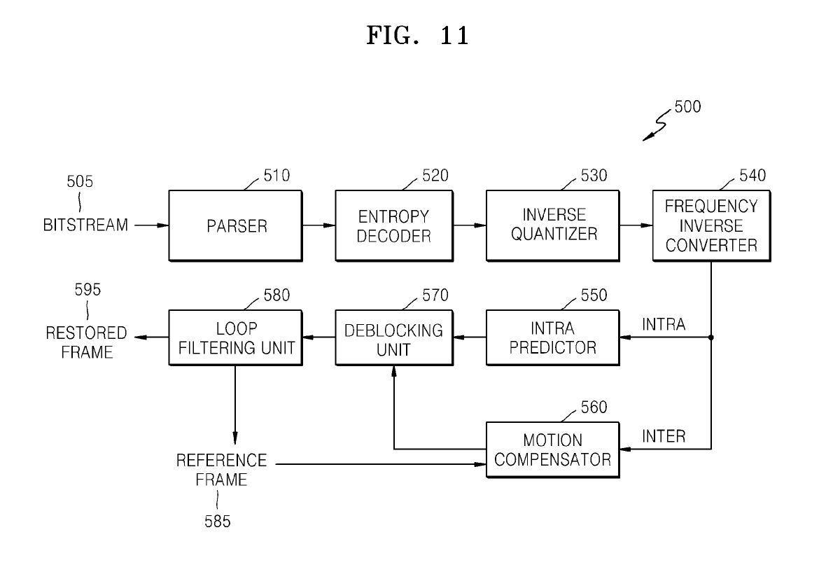

FIG. 11 is a block diagram of an image decoder 500 based on coding units, according to an exemplary embodiment.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through a frequency inverse converter 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking unit 570 and a loop filtering unit 580. Also, the image data that is post-processed through the deblocking unit 570 and the loop filtering unit 580 may be output as the reference frame 585.

In order to decode the image data in the image data decoder 230 of the video decoding apparatus 200, the image decoder 500 may perform operations that are performed after the parser 510 performs an operation.

In order for the image decoder 500 to be implemented in the video decoding apparatus 200, all elements of the image decoder 500, e.g., the parser 510, the entropy decoder 520, the inverse quantizer 530, the frequency inverse converter 540, the intra predictor 550, the motion compensator 560, the deblocking unit 570, and the loop filtering unit 580 perform operations based on coding units having a tree structure for each maximum coding unit.

Specifically, the intra predictor 550 and the motion compensator 560 perform operations based on partitions and a prediction mode for each of the coding units having a tree structure, and the frequency inverse converter 540 performs operations based on a size of a transformation unit for each coding unit. Specifically, the decoder 520 may correspond to the subregion entropy decoder 24 of the video decoding apparatus 20 according to an exemplary embodiment.

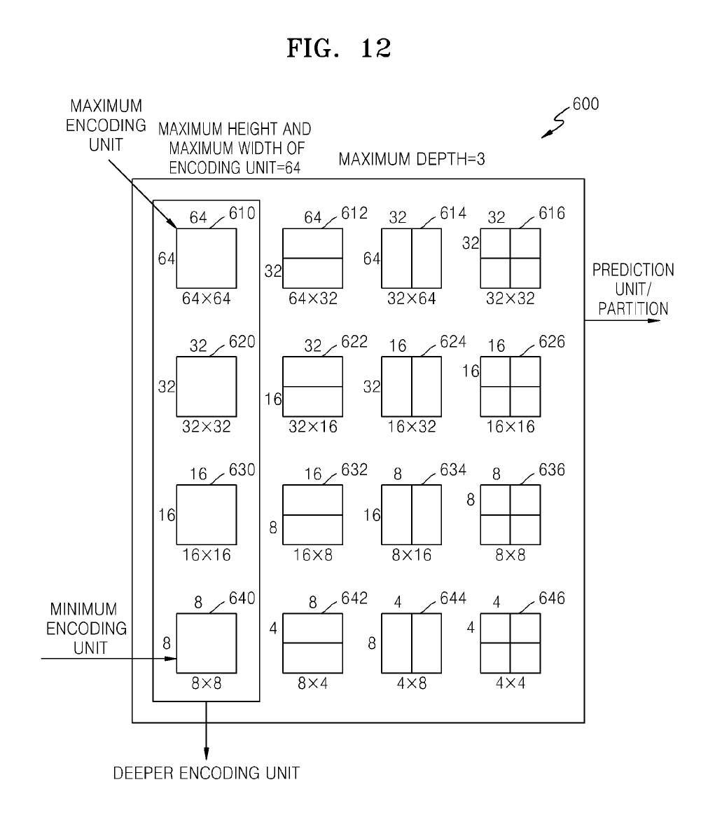

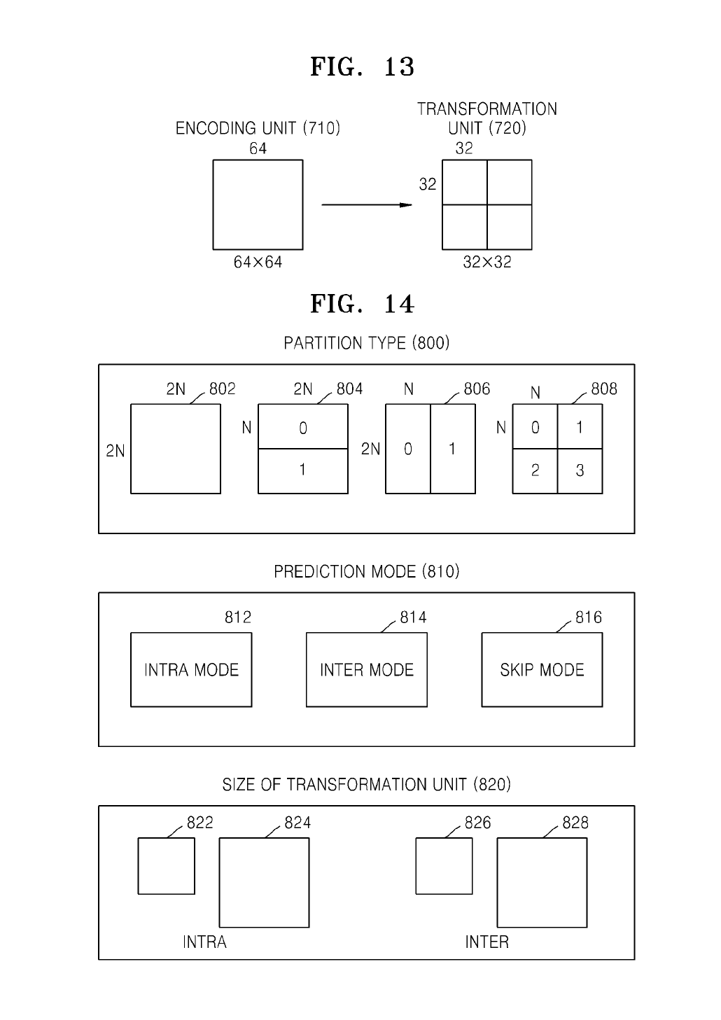

FIG. 12 is a diagram illustrating deeper coding units according to depths, and partitions, according to an exemplary embodiment.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an exemplary embodiment, the maximum height and the maximum width of the coding units are each 64, and the maximum depth is 4. In this case, the maximum depth refers to a total number of times the coding unit is split from the maximum coding unit to the minimum coding unit. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, e.g., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. It is understood that other coding units, e.g., coding units having a size of 4×4 and a depth of 4, may also exist. The coding unit 640 having the size of 8×8 and the depth of 4 may be a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the encoding unit 610, e.g., a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, e.g., a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, e.g., a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, e.g., a partition having a size of 8×8 included in the coding unit 640, partitions 642 having a size of 8×4, partitions 644 having a size of 4×8, and partitions 646 having a size of 4×4.

A coding unit having the size of 4×4 and a depth of 4 may be the minimum coding unit and a coding unit of the lowermost depth. A prediction unit of the coding unit 650 may only be assigned to a partition having a size of 4×4.

In order to determine the at least one coded depth of the coding units constituting the maximum coding unit 610, the coding unit determiner 120 of the video encoding apparatus 100 according to an exemplary embodiment performs encoding for of the coding units corresponding to each depth included in the maximum coding unit 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the maximum coding unit 610 may be selected as the coded depth and a partition type of the maximum coding unit 610.

FIG. 13 is a diagram for describing a relationship between a coding unit 710 and transformation units 720, according to an exemplary embodiment.

The video encoding apparatus 100 according to an exemplary embodiment or the video decoding apparatus 200 according to an exemplary embodiment encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 according to an exemplary embodiment or the video decoding apparatus 200 according to an exemplary embodiment, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 14 is a diagram for describing encoding information of coding units corresponding to a coded depth, according to an exemplary embodiment.

The output unit 130 of the video encoding apparatus 100 according to an exemplary embodiment may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, e.g., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 according to an exemplary embodiment may extract and use the information 800, 810, and 820 for decoding, according to each deeper coding unit.

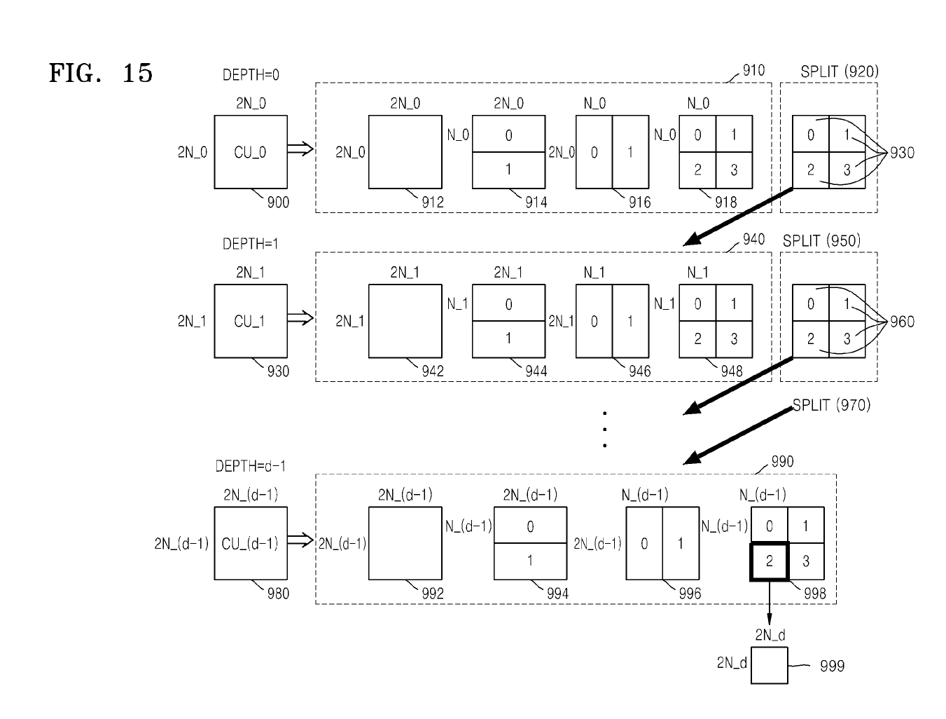

FIG. 15 is a diagram of deeper coding units according to depths, according to an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912, 914, 916, and 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition types 912, 914, and 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 has the minimum encoding error, since a maximum depth is d, a coding unit CU_(d−1) having a depth of d−1 is no longer split to a lower depth, and a coded depth for the coding units constituting a current maximum coding unit 900 is determined to be d−1 and a partition type of the current maximum coding unit 900 may be determined to be N_(d−1)×N_(d−1). Also, since the maximum depth is d and a minimum coding unit 980 having a lowermost depth of d−1 is no longer split to a lower depth, split information for the minimum coding unit 980 is not set.

A data unit 999 may be a ‘minimum unit’ for the current maximum coding unit. A minimum unit according to an exemplary embodiment may be a rectangular data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to ‘1’.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

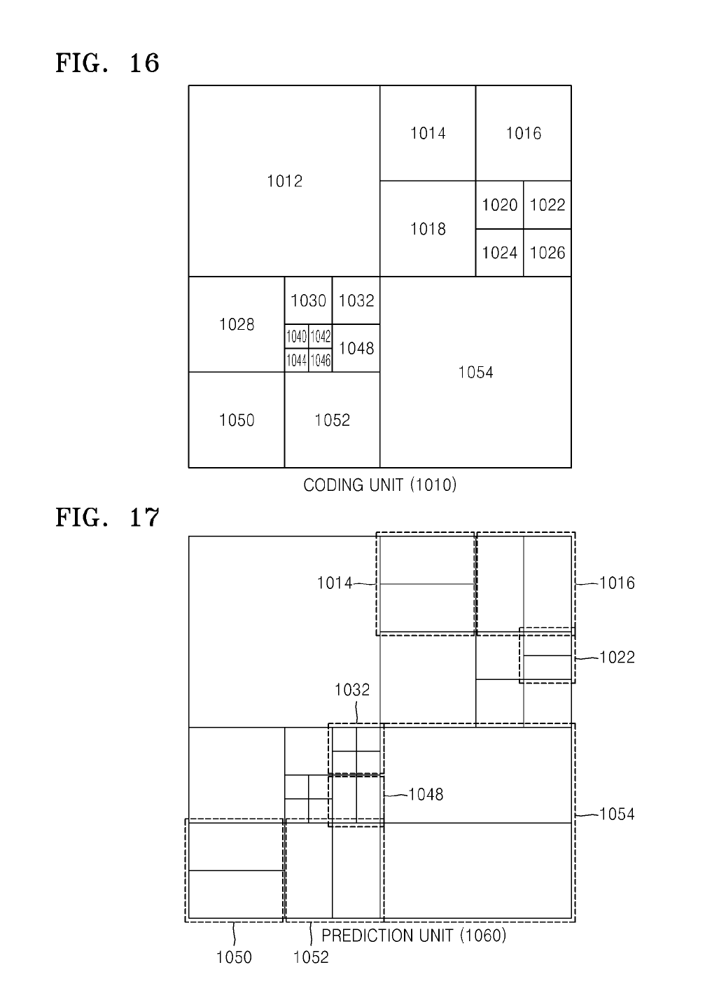

FIGS. 16, 17, and 18 are diagrams for describing a relationship between coding units, prediction units, and transformation units, according to an exemplary embodiment.

The coding units 1010 are coding units having a tree structure, corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding apparatus 100 according to an exemplary embodiment and the video decoding apparatus 200 according to an exemplary embodiment may perform intra prediction, motion estimation, motion compensation, transformation, and inverse transformation individually on a data unit in the same coding unit.

Accordingly, encoding is recursively performed on each of the coding units having a hierarchical structure in each region of a maximum coding unit to determine an optimum coding unit, and thus, coding units having a recursive tree structure may be obtained. Encoding information may include split information about a coding unit, information about a partition type, information about a prediction mode, and information about a size of a transformation unit. Table 1 shows the encoding information that may be set by the video encoding apparatus 100 according to an exemplary embodiment and the video decoding apparatus 200 according to an exemplary embodiment.

TABLE 1

| Split Information 0 | | | | | |
|---|---|---|---|---|---|
| (Encoding on Coding Unit having Size of 2N × 2N and Current Depth of d) | | | | | |
| | | | Size of | | |
| | | | Transformation Unit | | |
| | | | Split | Split | |
| | Partition Type | | Information 0 | Information 1 | |
| | Symmetrical | Asymmetrical | of | of | |
| Prediction | Partition | Partition | Transformation | Transformation | Split |
| Mode | Type | Type | Unit | Unit | Information 1 |
| Intra | 2N × 2N | 2N × nU | 2N × 2N | N × N | Repeatedly |
| Inter | 2N × N | 2N × nD | | (Symmetrical | Encode |
| Skip | N × 2N | nL × 2N | | Partition Type) | Coding Units |
| (Only | N × N | nR × 2N | | N/2 × N/2 | having |
| 2N × 2N) | | | | (Asymmetrical | Lower Depth |
| | | | | Partition Type) | of d + 1 |

The output unit 130 of the video encoding apparatus 100 according to an exemplary embodiment may output the encoding information about the coding units having a tree structure, and the image data and encoding information extractor 220 of the video decoding apparatus 200 according to an exemplary embodiment may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus, information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus, a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred to for predicting the current coding unit.

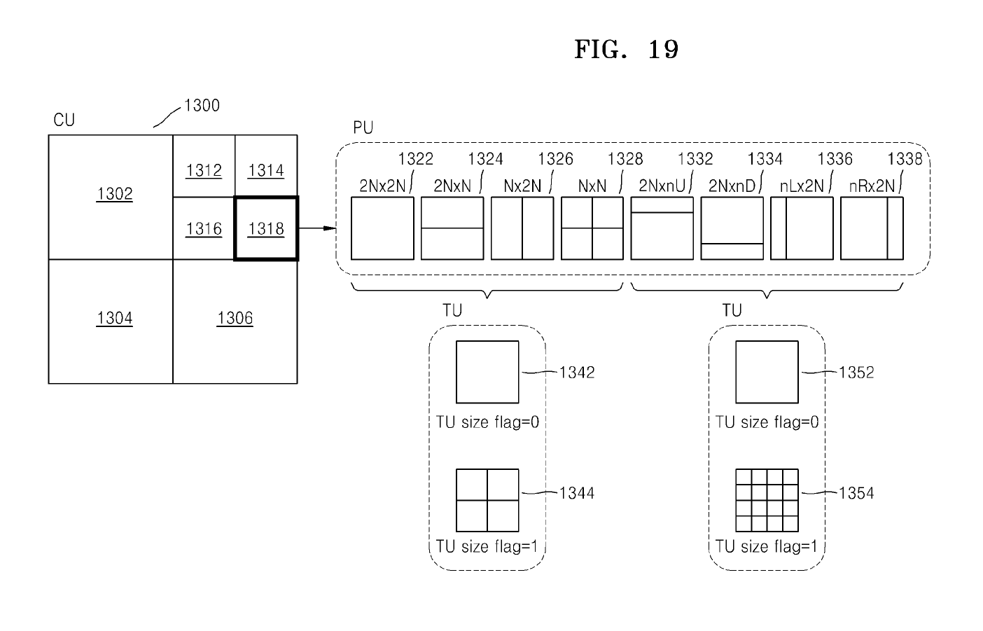

FIG. 19 is a diagram for describing a relationship between a coding unit, a prediction unit or a partition, and a transformation unit, according to encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Split information (TU (Transformation Unit)size flag) of a transformation unit is a type of a transformation index. The size of the transformation unit corresponding to the transformation index may be changed according to a prediction unit type or partition type of the coding unit.

For example, when the partition type is set to be symmetrical, e.g., the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

When the partition type is set to be asymmetrical, e.g., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 19, the TU size flag is a flag having a value or 0 or 1, but the TU size flag is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to an exemplary embodiment, together with a maximum size and minimum size of the transformation unit according to an exemplary embodiment. The video encoding apparatus 100 according to an exemplary embodiment is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 according to an exemplary embodiment may decode video by using the maximum transformation unit size information, the minimum transformation unit size information, and the maximum TU size flag.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

The maximum transformation unit size RootTuSize according to an exemplary embodiment may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ according to an exemplary embodiment that varies according to the type of a prediction mode in a partition unit is just an example and the exemplary embodiments are not limited thereto.

According to the video encoding method based on coding units having a tree structure as described with reference to FIGS. 7 through 19, image data of a spatial region is encoded for each coding unit of a tree structure. According to the video decoding method based on coding units having a tree structure, decoding is performed for each maximum coding unit to restore image data of a spatial region. Thus, a picture and a video that is a picture sequence may be restored. The restored video may be reproduced by a reproducing apparatus, stored in a storage medium, or transmitted through a network.

The exemplary embodiments may be written as computer programs and may be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs).

For convenience of description, the video encoding method including the entropy encoding method described above with reference to FIGS. 1A through 19 is referred to as a ‘video encoding method according to the exemplary embodiments.’ Also, the video decoding method including the entropy decoding method described above with reference to FIGS. 1A through 19 is referred to as a ‘video decoding method according to the exemplary embodiments.’

Also, a video encoding apparatus including the video encoding apparatus 100 or the video encoding apparatus 10 described above with reference to FIGS. 1A through 19 and the image encoder 400 will be referred to as a ‘video encoding apparatus according to the exemplary embodiments.’ Also, a video decoding apparatus 200 including the video decoding apparatus 200 or the video decoding apparatus 20 described above with reference to FIGS. 1A through 19 and the image decoder 500 will be referred to as a ‘video decoding apparatus according to the exemplary embodiments.’

Hereinafter, an exemplary embodiment will be described in which a computer readable storage medium storing a program is a disk 26000 according to an exemplary embodiment.

FIG. 20 illustrates a physical structure of a disk 26000 according to an exemplary embodiment in which a program according to an exemplary embodiment is stored. The disk 26000 described above as a storage medium may be a hard drive, a CD-ROM disk, a Blu-ray disk, or a DVD disk. The disk 26000 is formed of a plurality of concentric tracks tr, and the tracks tr are divided into a predetermined number of sectors Se in a circumferential direction. Programs which, when executed, perform the method of determining a quantization parameter, the video encoding method, and the video decoding method described above according to the exemplary embodiments may be assigned and stored in a predetermined area of the disk 26000 that stores the programs according to an exemplary embodiment described above.

A computer system that is implemented by using a storage medium storing a program for implementing the video encoding method and the video decoding method described above will be described with reference to FIG. 21.

FIG. 21 illustrates a disk drive 26800 that writes and reads a program from the disk 26000. A computer 26700 may store on the disk 26000 a program for executing at least one of the video encoding method and the video decoding method according to the exemplary embodiments. In order for the computer system 26700 to execute the program stored in the disk 26000, the program may be read from the disk 26000 via the disk drive 26800, and the program may be transmitted to the computer system 26700.

In addition to the disk 26000 illustrated in FIGS. 20 and 21, a memory card, a ROM cassette, or a solid state drive (SSD) may also store a program for executing at least one of the video encoding method and the video decoding method according to the exemplary embodiments.

A system to which the video encoding method and the video decoding method according to the above-described exemplary embodiments may be applied will be described below.

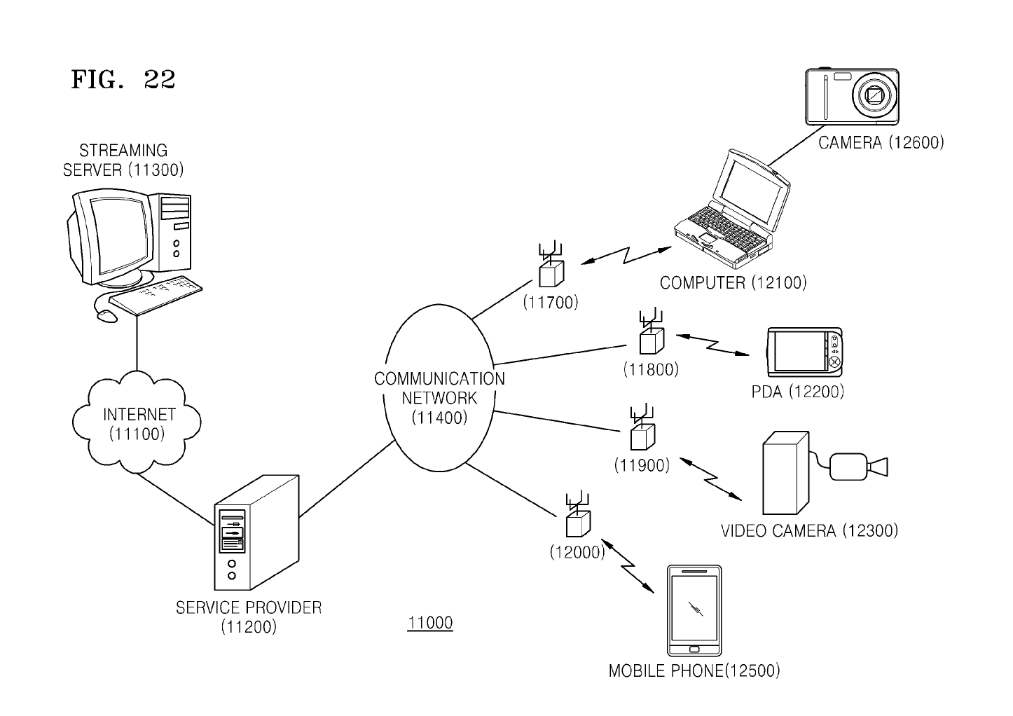

FIG. 22 illustrates an overall structure of a content supply system 11000 for providing a content distribution service. A service area of a communication system is split into cells having a predetermined size, and wireless base stations 11700, 11800, 11900, and 12000 are installed in each cell.

The content supply system 11000 includes multiple independent devices. For example, independent devices such as a computer 12100, a personal digital assistant (PDA) 12200, a camera 12300, and a mobile phone 12500 are connected to the Internet 11000 via an Internet service provider 11200, a communication network 11400, and the wireless base stations 11700, 11800, 11900, and 12000.

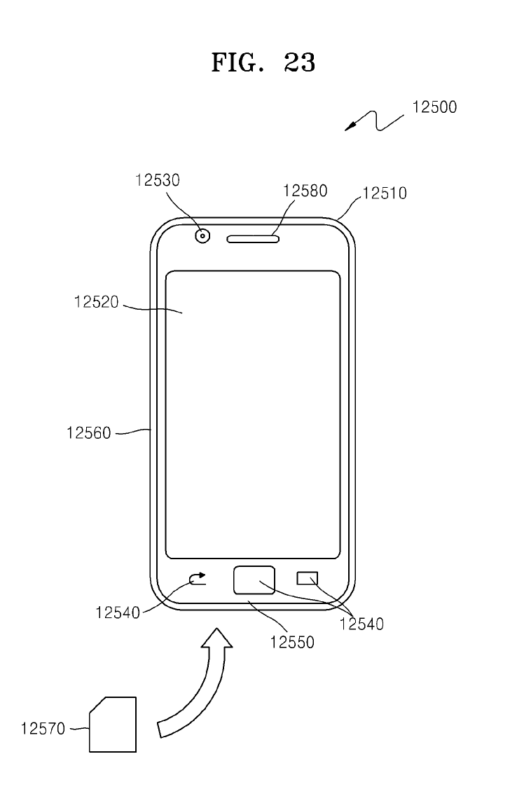

However, the content supply system 11000 is not limited to a structure as illustrated in FIG. 23, but devices may be selectively connected to the content supply system 11000. Independent devices may be directly connected to the communication network 11400 without being connected via the wireless base stations 11700, 11800, 11900, and 12000.

The video camera 12300 is an image capturing device capable of capturing a video image, such as a digital video camera. The mobile phone 12500 may select at least one communication method from among various protocols such as Personal Digital Communications (PDC), code division multiple access (CDMA), wideband code division multiple access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 may stream content that is transmitted to the streaming server 11300 in real-time from the video camera 12300 operated by a user. Content received from the video camera 12300 may be encoded by using the video camera 12300 or the streaming server 11300. Video data obtained by using the video camera 12300 may also be transmitted to the streaming server 11300 via the computer 12100.

Video data obtained by using the camera 12600 may also be transmitted to the streaming server 11300 via the computer 12100. The camera 12600 is an image capturing device which is capable of capturing both a still image and a video image, such as a digital camera. Video data received from the camera 12600 may be encoded by using the camera 12600 or the computer 12100. Software for video encoding and decoding may be stored in a computer readable recording medium such as a CD-ROM disk, a floppy disk, a hard disk drive, an SSD, or a memory card which the computer 12100 may access.

Also, if a video is captured by using a camera mounted in the mobile phone 12500, video data may be received from the mobile phone 12500.

Video data may be encoded by using a large scale integrated circuit (LSI) system mounted in the video camera 12300, the mobile phone 12500, or the camera 12600.

In the content supply system 11000 according to an exemplary embodiment, content that is recorded by a user by using the video camera 12300, the camera 12600, the mobile phone 12500, or other image capturing device, for example, content which is a recording of a concert is encoded and transmitted to the streaming server 11300. The streaming server 11300 may stream content data to other clients that have requested content data.

Clients are devices that are capable of decoding encoded content data, and may be, for example, the computer 12100, the PDA 12200, the video camera 12300, or the mobile phone 12500. Accordingly, the content supply system 11000 may allow the clients to receive encoded content data and reproduce the same. Also, the content supply system 11000 may allow the clients to receive encoded content data to decode and reproduce the same in real-time, thereby enabling personal broadcasting.

The video encoding apparatus and the video decoding apparatus according to the exemplary embodiments may be implemented as independent devices included in the content supply system 11000 to perform an encoding operation and a decoding operation.

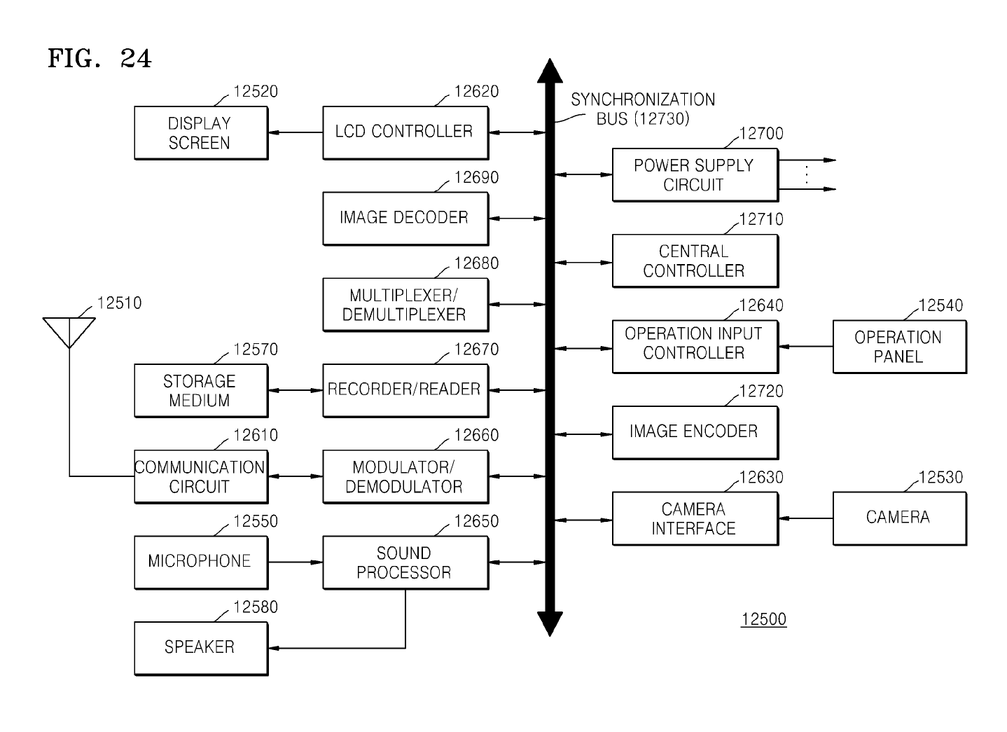

An example of the mobile phone 12500 of the content supply system 11000 will be described in detail below with reference to FIGS. 23 and 24.

FIGS. 23 and 24 respectively illustrate an external structure and an internal structure of the mobile phone 12500 which may perform a video encoding method and a video decoding method according to an exemplary embodiment.

FIG. 23 illustrates an external structure of the mobile phone 12500 which may perform the video encoding method and the video decoding method according to an exemplary embodiment. The mobile phone 12500 may be a smartphone having a functionality which is not limited but may be modified or extended via an application program.

The mobile phone 12500 includes an internal antenna 12510 via which the mobile phone 12500 exchanges an RF signal with the wireless base station 12000, and includes a display screen 12510 such as a liquid crystal display (LCD) screen or an organic light emitting diode (OLED) screen which displays images captured by using the camera 12530 or images that are received via the antenna 12510 to be decoded. A mobile phone 12500 may include an operation panel 12540 including a control button and a touch panel or the like. If the display screen 12520 is a touch screen, the operation panel 12540 further includes a touch sensing panel of the display screen 12520. The smartphone 12510 includes a speaker 12580 or another type of sound output unit for outputting voice or sound and a microphone 12550 or another type of sound input unit for inputting voice or sound. The smartphone 12510 further includes a camera 12530 such as a charged coupled device (CCD) camera to capture a video image or a still image. Also, the smartphone 12510 may include a storage medium 12570 for storing encoded or decoded data such as a video or still images that are captured by using the camera 12530, received via an e-mail, or obtained in other forms, and a slot 12560 for mounting the storing medium 12570 on the mobile phone 12500. The storage medium 12570 may be another type of flash memory such as an SD card or an electrically erasable and programmable read only memory (EEPROM).

FIG. 24 illustrates an internal structure of the mobile phone 12500. In order to systematically control respective portions of the mobile phone 12500 formed of the display screen 12520 and the operation panel 12540, a power supply circuit 12700, an operation input control unit 12640 (e.g., operation input controller), an image encoder 12720, a camera interface 12630, an LCD control unit 12620 (e.g., LCD controller), an image decoder 12690, a multiplexer/demultiplexer 12680, a recording/reading unit 12670 (e.g., recorder/reader), a modulation/demodulation unit 12660 (e.g., modulator/demodulator), and a sound processing unit 12650 (e.g., sound processor) are connected to a central control unit 12710 (e.g., central controller) via a synchronization bus 12730.

When the user presses a power button so that the mobile phone 12500 enters a ‘power on’ state from a ‘power off’ state, power may be supplied through the power supply circuit 12700 from a battery pack to each portion of the mobile phone 12500, thereby setting the mobile phone 12500 in an operational mode.

The central control unit 1270 includes a central processing unit (CPU), a read only memory (ROM), and a random access memory (RAM).

While the mobile phone 12500 transmits communication data to the outside, a digital signal is generated in the mobile phone 12500 according to a control by the central control unit 12710. For example, a digital sound signal is generated in the sound processing unit 12650, and a digital image signal is generated in the image encoder 12720, and text data of a message may be generated by using the operational panel 12540 and the operation input control unit 12640. When a digital signal is transmitted to the modulation/demodulation unit 12660 according to a control by the central control unit 12710, the modulation/demodulation unit 12660 may modulate a frequency band of a digital sound signal, and the communication circuit 12610 performs digital-analog (D/A) conversion and frequency conversion processes on the band-modulated digital sound signal. A transmission signal output from the communication circuit 12610 may be transmitted to a sound communication base station or the wireless base station 12000 via the antenna 12510.

For example, a sound signal obtained by using the microphone 12550 when the mobile phone 12500 is in a call mode, is converted into a digital sound signal by using the sound processing unit 12650 according to a control by the central control unit 12710. The generated digital sound signal may be converted into a transmission signal via the modulation/demodulation 12660 and the communication circuit 12610 and may be transmitted via the antenna 12510.

When a message, such as a text message or an email, is transmitted in a data communication mode, text data of a message is input by using the operation panel 12540, and the text data is transmitted to the central control unit 12610 via the operation input control unit 12640. According to a control by the central control unit 12610, the text data is converted into a transmission signal via the modulation/demodulation unit 12660 and the communication circuit 12610 and transmitted to the wireless base station 12000 via the antenna 12510.

In order to transmit image data in a data communication mode, image data captured by using the camera 12530 is provided to the image encoder 12720 via a camera interface 12630. The image data captured by using the camera 12530 may be immediately displayed on the display screen 12520 via the camera interface 12630 and the LCD control unit 12620.

A structure of the image encoder 12720 may correspond to a structure of the video encoding apparatus according to the exemplary embodiments described above. The image encoder 12720 may encode image data captured by using the camera 12530 according to the video encoding method according to the exemplary embodiments described above to convert the image data into a compression-encoded image, and may output encoded image data to the multiplexer/demultiplexer 12680. A sound signal obtained by using the microphone 12550 of the mobile phone 12500 during recording by using the camera 12530 may be converted into digital sound data via the sound processing unit 12650, and the digital sound data may be transmitted to the multiplexer/demultiplexer 12680.

The multiplexer/demultiplexer 12680 multiplexes encoded image data provided by the image encoder 12720 together with sound data provided by the sound processing unit 12650. The multiplexed data may be converted into a transmission signal via the modulation/demodulation unit 12660 and the communication circuit 12610 and may be transmitted via the antenna 12510.

When the mobile phone 12500 receives communication data from the outside, a signal received via the antenna 12510 is converted into a digital signal by frequency recovery and analog-to-digital (A/D) conversion. The modulation/demodulation unit 12660 modulates a frequency band of a digital signal. The band-modulated digital signal is transmitted to the image decoder 12690, the sound processing unit 12650, or the LCD control unit 12620.

In a call mode, the mobile phone 12500 amplifies a signal received via the antenna 12510, and generates a digital sound signal via frequency conversion and A/D conversion processing. The received digital sound signal passes through the modulation/demodulation unit 12660 and the sound processing unit 12650 according to a control by the central control unit 12710 and is converted into an analog sound signal, and the analog sound signal is output through the speaker 12580.

In a data communication mode, when data of a video file accessed through an Internet website is received, a signal received from the wireless base station 12000 via the antenna 12510 outputs multiplexed data that has been processed by the modulation/demodulation unit 12660, and the multiplexed data is transmitted to the multiplexer/demultiplexer 12680.

In order to decode the multiplexed data received via the antenna 12510, the multiplexer/demultiplexer 12680 demultiplexes the multiplexed data to separate an encoded video data stream and an encoded audio data stream. Through the synchronization bus 12730, the encoded video data stream is provided to the image decoder 12690, and the encoded audio data stream is provided to the sound processing unit 12650.

A structure of the image decoder 12690 may correspond to a structure of the video decoding apparatus according to the exemplary embodiments described above. The image decoder 12690 may decode encoded video data to generate restored video data by using the video decoding method according to the exemplary embodiments described above, and may provide the display screen 1252 with restored video data via the LCD control unit 1262.

Accordingly, video data of a video file accessed through an Internet website may be displayed on the display screen 1252. At the same time, the sound processing unit 12650 may convert audio data into an analog sound signal, and may provide the analog sound signal to the speaker 12580. Accordingly, the audio data included in the video file accessed through an Internet website may also be replayed through the speaker 12580.

The mobile phone 12500 or another type of communication terminal may be a transmission and reception terminal that includes both the video encoding apparatus and the video decoding apparatus according to the exemplary embodiments, a transmission terminal including only the video encoding apparatus according to the exemplary embodiments, or a reception terminal including only the video decoding apparatus according to the exemplary embodiments.

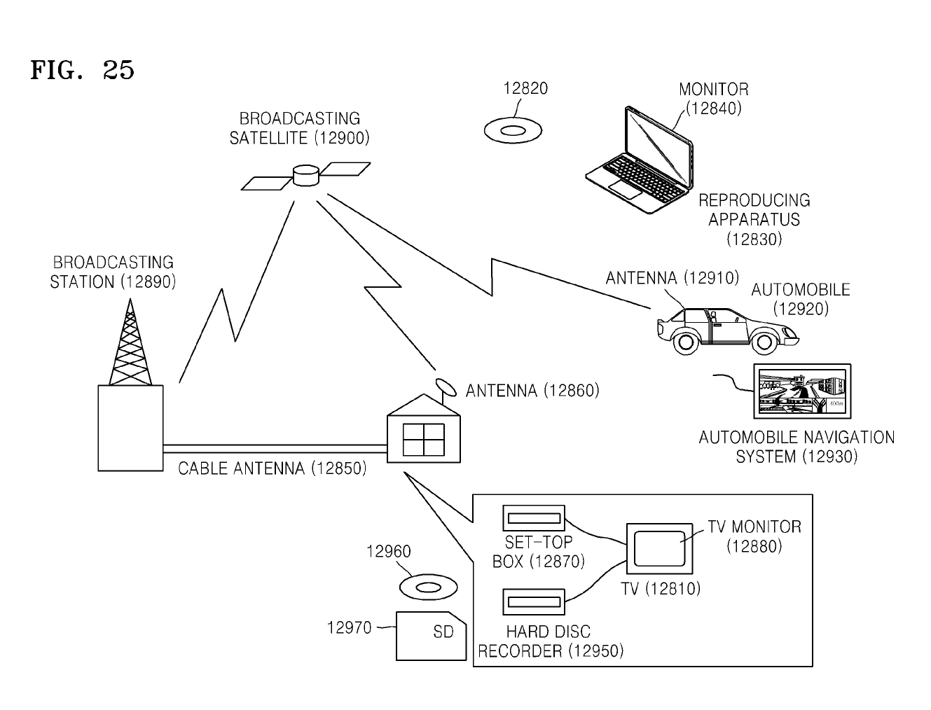

The communication system according to the exemplary embodiments is not limited to the above-described structure described with reference to FIG. 23. For example, FIG. 25 illustrates a digital broadcasting system to which a communication system according to an exemplary embodiment is applied. The digital broadcasting system according to an exemplary embodiment, illustrated in FIG. 25, may receive digital broadcasting content which is transmitted via a satellite or a terrestrial network by using the video encoding apparatus or the video decoding apparatus according to the exemplary embodiment.

In detail, a broadcasting station 12890 transmits a video data stream via radio waves to a communication satellite or a broadcasting satellite 12900. The broadcasting satellite 12900 transmits a broadcasting signal, and the broadcasting signal is received by a satellite broadcasting receiver via the antenna 12860 at homes. In each home, the encoded video stream may be decoded to be replayed by using a TV receiver 12810, the set top box 12870, or other devices.

As the video decoding apparatus according to the exemplary embodiments is implemented in the reproducing apparatus 12830, the reproducing apparatus 12830 may read and decode an encoded video stream written to the storage medium 12820 such as a disk or a memory card. Accordingly, a restored video signal may be replayed, for example, on the monitor 12840.

The video decoding apparatus according to the exemplary embodiments may also be mounted in the set top box 12870 connected to the antenna 12860 for satellite/terrestrial broadcasting or a cable antenna 12850 for cable TV reception. Output data of the set top box 12870 may also be replayed on a TV monitor 12880.

Alternatively, instead of being mounted in the set top box 12870, the video decoding apparatus according to the exemplary embodiments may be mounted in the TV receiver 12810.

An automobile 12920 including an antenna 12910 that is appropriately configured may receive a signal transmitted from the satellite 12900 or the wireless base station 11700. A decoded video may be replayed on a display screen of an automobile navigation system 12930 mounted in the automobile 12920.

A video signal may be decoded by using the video decoding apparatus according to the exemplary embodiments and may be written to and stored in a storage medium. In detail, an image signal may be stored in a DVD disk 12960 by using a DVD recorder, or an image signal may be stored in a hard disk by using a hard disk recorder 12950. Alternatively, a video signal may be stored in an SD card 12970. When the hard disk recorder 12950 includes the video decoding apparatus according to the exemplary embodiments, the video signal written to the DVD disk 12960, the SD card 12970 or another type of storage medium may be replayed on the monitor 12880.

The automobile navigation system 12930 may not include the camera 12530, the camera interface 12630, and the image decoder 12720 of FIG. 25. For example, the computer 12100 and the TV receiver 12810 may also not include the camera 12530, the camera interface 12630, and the image decoder 12720 of FIG. 25.

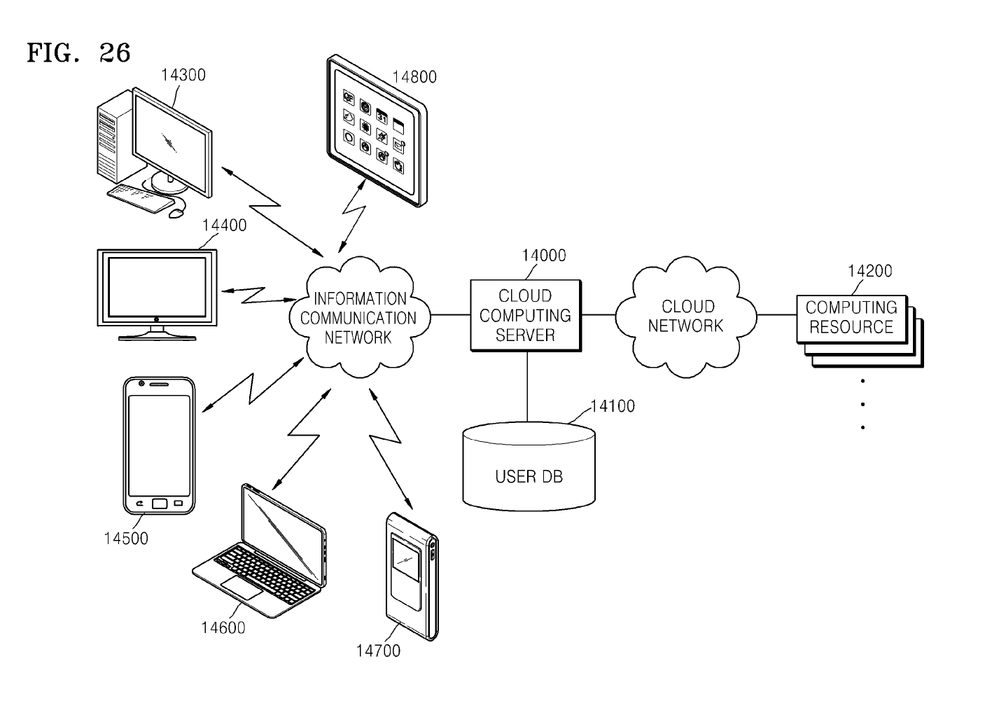

FIG. 26 illustrates a network structure of a cloud computing system that uses a video encoding apparatus and a video decoding apparatus according to an exemplary embodiment.

The cloud computing system according to the exemplary embodiments may be formed of a cloud computing server 14100, a user DB 14100, a computing resource 14200, and a user terminal.

The cloud computing system provides an on-demand outsourcing service of a computing resource via an information communication network such as the Internet, upon a request of a user terminal. In a cloud computing environment, a service provider provides a requested service to users by integrating computing resources of a data center that are located at different physical locations, by using virtualization technology. Instead of installing services and computing resources such as an application, storage, an operating system (OS), or security software, a service user may select from any number of services installed in a virtual space generated by using the virtualization technology, at any desired time.

A user terminal of a predetermined service user is used to access the computing server 14100 via an information communication network including the Internet and a mobile communication network. User terminals may be provided with a cloud computing service, for example, a video replay service, from the cloud computing server 14100. A user terminal may be any Internet-accessible electronic device such as a desktop PC 14300, a smart TV 14400, a smartphone 14500, a laptop computer 14600, a portable multimedia player (PMP) 14700, or a tablet PC 14800.

The cloud computing server 14100 may integrate a plurality of computing resources 14200 distributed over a cloud network to provide the same to a user terminal. The plurality of computing resources 14200 include various data services, and may include data uploaded from a user terminal. In this manner, the cloud computing server 14100 may integrate a video image database distributed among various locations by using virtualization technology to provide a service requested by a user terminal.

In the user DB 14100, user information of a user who has subscribed to a cloud computing service is stored. Here, user information may include personal information such as login information, an address, and a name. Also, user information may include an index of a video image. An index may include a list of videos that have been replayed completely, a list of videos currently being replayed, and a stopping point of a video being replayed.

Information about videos, which is stored in the user DB 14100, may be shared among user devices. Accordingly, for example, if a predetermined video service that is requested by the laptop computer 14600 is provided to the laptop computer 14600, a replay history of videos provided by the predetermined video service is stored in the user DB 14100. When the same video service is being requested by the smartphone 14500, the cloud computing server 14100 refers to the user DB and searches for the predetermined video service to replay videos provided by the predetermined video service. When the smartphone 14500 receives a video data stream via the cloud computing server 14100, an operation of decoding the video data stream and replaying the same is similar to the operation of the mobile phone 12500 described above with reference to FIG. 23.

The cloud computing server 14100 may refer to a replay history of videos provided by a predetermined video service stored in the user DB 14100. For example, the cloud computing server 14100 receives a replay request for a video stored in the user DB 14100. If the video has been replayed before, the cloud computing server 14100 may use different streaming methods according to whether the video is to be replayed from the beginning or from a previous stopping point according to selection by a user terminal. For example, if a user terminal has requested to replay the video from the beginning, the cloud computing server 14100 streams the corresponding video to the user terminal from a first frame. On the other hand, if the user terminal has requested to replay the video from the previous stopping point, the cloud computing server 14100 streams the corresponding video to the user terminal from a frame corresponding to the stopping point.

Here, the user terminal may include the video decoding apparatus according to the exemplary embodiments described above with reference to FIGS. 1A through 20. Alternatively, the user terminal may include the video encoding apparatus according to the exemplary embodiments described above with reference to FIGS. 1A through 20. Also, the user terminal may include both the video encoding apparatus and the video decoding apparatus according to the exemplary embodiments described above with reference to FIGS. 1A through 20.

Various applications to which the video encoding method and the video decoding method according to the exemplary embodiments and the video encoding apparatus and the video decoding apparatus according to the exemplary embodiments described above with reference to FIGS. 1A through 20 are applied have been described with reference to FIGS. 20 through 26. However, the various applications in which the video encoding method and the video decoding method according to the exemplary embodiments described above with reference to FIGS. 1A through 19 are stored in a storage medium or in which the video encoding apparatus and the video decoding apparatus according to the exemplary embodiments are implemented in a device are not limited to the applications of FIGS. 20 through 26.

While the exemplary embodiments have been particularly shown and described with reference to certain exemplary embodiments thereof, it will be understood by those of ordinary skill in the art that various changes in form and details may be made therein without departing from the spirit and scope of the exemplary embodiments as defined by the appended claims. The exemplary embodiments should be considered in a descriptive sense only and not for purposes of limitation. Therefore, the scope of the exemplary embodiments is defined not by the detailed description but by the appended claims, and all differences within the scope will be construed as being included in the exemplary embodiments.

1. A video encoding method in which entropy encoding is performed, the method comprising:
generating encoding symbols by performing source coding on subregions which are formed by splitting a picture in a vertical direction, wherein the performing of the source coding comprises performing the source coding based on blocks having a predetermined size;
determining a reference block to be referred to for determining code probability information of a start block in a current subregion, the reference block being determined from among boundary blocks of a neighboring subregion which neighbors the current subregion, the boundary blocks being encoded before the start block and adjacent to a boundary between the current subregion and the neighboring subregion;
performing entropy encoding on blocks of the current subregion, starting from the start block, by using the encoding symbols of the blocks of the current subregion based on the code probability information of the start block determined by using code probability information of the determined reference block; and
performing entropy encoding on a predetermined subregion from among the subregions in parallel with performing entropy encoding on the current subregion.

2. The video encoding method of claim 1, wherein the determining of the reference block to be referred to comprises determining the reference block to be referred to from among at least one block located at a position designated based on a location of the start block.

3. The video encoding method of claim 2, further comprising outputting information indicating a location of the determined reference block.

4. The video encoding method of claim 1, wherein the generating of the encoding symbols comprises performing prediction encoding on the current subregion by referring to a subregion that is encoded before the current subregion and is among the subregions.

5. A video encoding method in which entropy encoding is performed, the video encoding method comprising:
generating encoding symbols by performing source coding on subregions which are formed by splitting a picture in a vertical direction, wherein the source coding is performed based on blocks having a predetermined size;
performing entropy encoding by using entropy symbols of the current subregion;
outputting reference possibility information indicating whether it is possible to perform entropy encoding on the current subregion by referring to a neighboring subregion; and
performing entropy encoding on a predetermined subregion from among the subregions, in parallel with the performing of the entropy encoding on the current subregion, based on the output reference possibility information.

6. The video encoding method of claim 5, wherein the performing of the entropy encoding on the predetermined subregion comprises:
determining a block to be referred to for determining code probability information of a start block in a current subregion from among boundary blocks of a neighboring subregion which neighbors the current subregion, the boundary blocks being encoded before the start block and adjacent to a boundary between the current subregion and the neighboring subregion; and
sequentially performing entropy encoding on blocks of the current subregion, starting from the start block, based on the code probability information of the start block determined by using code probability information of the determined block.

7. A video decoding method in which entropy decoding is performed, the video decoding method comprising:
extracting from a received bitstream an encoded bit string of encoding symbols of a current subregion generated based on blocks having a predetermined size, for subregions that are formed by splitting a picture in a vertical direction;
determining a block that is to be referred to for determining code probability information of a start block in a current subregion from among boundary blocks of a neighboring subregion which neighbors the current subregion, the boundary blocks being encoded before the start block and adjacent to a boundary between the current subregion and the neighboring subregion;
restoring the encoding symbols of the current subregion by performing entropy decoding on the encoded bit string of the encoding symbols of the current subregion based on the code probability information of the start block determined by using code probability information of the determined block;
performing entropy decoding on a predetermined subregion from among the subregions in parallel with performing entropy decoding on the current subregion; and
restoring the picture by performing source decoding on the restored encoding symbols, for each of the subregions.

8. The video decoding method of claim 7, wherein the determining of the block that is to be referred to comprises determining a block to be referred to from among at least one block located at a position designated based on a location of the start block.

9. The video decoding method of claim 8, wherein the extracting comprises extracting from the received bitstream information indicating a location of the block that is to be referred to for determining the code probability information of the start block of the current subregion, and
the determining of the block that is to be referred to comprises determining the block that is to be referred to according to a location of a block read from the extracted information.

10. The video decoding method of claim 7, wherein the restoring of the picture comprises restoring the picture by estimating the current subregion by referring to a subregion from among subregions that are restored before the current subregion.

11. A video decoding method in which entropy decoding is performed, the video decoding method comprising:
extracting from a received bitstream an encoded bit string of encoding symbols of a current subregion generated based on blocks having a predetermined size, for subregions that are formed by splitting a picture in a vertical direction;
extracting from the received bitstream entropy reference possibility information indicating whether it is possible to perform entropy decoding on a current subregion by referring to a parsing result of a neighboring subregion which neighbors the current subregion;
restoring the encoding symbols of the current subregion by performing entropy decoding on the encoded bit string of the encoding symbols of the current subregion based on the extracted entropy reference probability information;
performing entropy decoding on a predetermined subregion from among the subregions in parallel with performing entropy decoding on the current subregion; and
restoring the picture by performing source decoding on the restored encoding symbols, for each of the subregions.

12. The video decoding method of claim 11, wherein the restoring of the encoding symbols of the current subregion comprises:
determining a block that is to be referred to for determining code probability information of a start block in the current subregion from among boundary blocks of the neighboring subregion, the boundary blocks being encoded before the start block and adjacent to a boundary between the current subregion and the neighboring subregion; and
restoring the encoding symbols of the current subregion by performing entropy encoding on the encoded bit string of the encoding symbols of the current subregion based on the code probability information of the start block determined by using code probability information of the determined block.

13. A video encoding apparatus configured to perform entropy encoding, the apparatus comprising:
a subregion encoder configured to generate encoding symbols by performing source coding on subregions formed by splitting a picture, in a vertical direction, into blocks having a predetermined size;
a subregion entropy encoder configured to determine a reference block to be referred to for determining code probability information of a start block in a current subregion from among boundary blocks of a neighboring subregion which neighbors the current subregion, the boundary blocks being encoded before the start block and adjacent to a boundary between the current subregion and the neighboring subregion, and to perform entropy encoding on blocks of the current subregion, starting from the start block, by using the encoding symbols of the blocks of the current subregion based on the code probability information of the start block determined by using code probability information of the determined reference block,
wherein the subregion entropy encoder is configured to perform entropy encoding on a predetermined subregion from among the subregions in parallel with performing entropy encoding on the current subregion.

14. A video decoding apparatus configured to perform entropy decoding, the video decoding apparatus comprising:
a subregion receiver configured to extract from a received bitstream an encoded bit string of encoding symbols of a current subregion generated based on blocks having a predetermined size, for subregions that are formed by splitting a picture in a vertical direction;
a subregion entropy decoder configured to determine a block that is to be referred to for determining code probability information of a start block in the current subregion from among boundary blocks of a neighboring subregion which neighbors the current subregion, the boundary blocks being encoded before the start block and adjacent to a boundary between the current subregion and the neighboring subregion, and to restore the encoding symbols of the current subregion by performing entropy decoding on the encoded bit string of the encoding symbols of the current subregion based on the code probability information of the start block determined by using code probability information of the determined block; and
a restoring unit configured to restore the picture by performing source decoding on the restored encoding symbols of the subregions,
wherein the subregion entropy decoder is configured to perform entropy decoding on a predetermined subregion from among the subregions in parallel with performing entropy decoding on the current subregion.

15. A non-transitory computer readable recording medium having embodied thereon a program, which when executed by a computer, performs the method of claim 1.
